(19) United States
(12) Patent Application Publication
(10) Pub. No.: US 2026/0227117 A1
(43) Pub. Date: Aug. 6, 2026

(54) REFRIGERATOR

(71) Applicant: LG Electronics Inc., Seoul (KR)

(72) Inventor: Jiwoon KIM, Seoul (KR)

(73) Assignee: LG Electronics Inc., Seoul (KR)

(21) Appl. No.: 19/368,761

(22) Filed: Oct. 24, 2025

(30) Foreign Application Priority Data
Feb. 6, 2025 (KR) 10-2025-0015219

(51) Int. Cl. F25D 17/04; B01D 46/00

(52) U.S. Cl. CPC F25D 17/042; B01D 46/0005; B01D 46/0016; F25D 2317/0415; F25D 2323/00272

(57) ABSTRACT

Disclosed is a refrigerator in which a refrigerating compartment filter for deodorizing a refrigerating compartment is easily replaced using an assembly including a cold air guide into or from which a filter casing is inserted or is withdrawn and a cold air guide fixing portion hinge-coupled thereto.

### CROSS-REFERENCE TO RELATED APPLICATION

This application claims priority to and the benefit of Korean Patent Application No. 10-2025-0015219, filed on 2025.02.06, the disclosure of which is incorporated herein by reference in its entirety.

### BACKGROUND

### Field

The present disclosure relates to a refrigerator in which a filter is installed in a refrigerating compartment, and more particularly, to a refrigerator system which may allow a user to quickly replace a filter and to easily check whether the filter is installed in the refrigerator, and information on when to replace the filter.

### Description of Related Art

A refrigerator is a home appliance that supplies cold air generated via circulation of refrigerant to a storage compartment such as a refrigerating compartment or a freezing compartment, and stores various types of storage targets in the storage compartment in a fresh state for a long time.

In the related art, a scheme of installing a separate suction fan and a filter on a rear surface of the storage compartment to deodorize odors generated from the objects stored in the storage compartment has been employed. However, recently, a scheme of installing a filter assembly in a cold air discharge hole disposed in the rear surface of the storage compartment to obtain a deodorizing effect along with circulation of cold air has been employed.

However, since the filter assembly is fixedly installed on an upper surface or a rear surface of the storage compartment, it is difficult for users with weak force or a small body to detach and replace the filter that has been beyond the service life.

In addition, when the existing filter assembly is used, it is not possible for the user out of the refrigerator to check whether the filter thereof is installed inside the refrigerator and how long the use life of the filter remains.

Patent document 01 introduces a refrigerator deodorization scheme using a filter. However, in this scheme, the filter together with the suction fan is installed. Further, in order to replace the filter, the fan or a portion of the storage compartment should be removed. Thus, it is difficult for the user to easily replace the filter.

### Prior Art Literature

### Patent document

(Patent Document 1) Korean Patent Application Publication No. 10-2003-0026104 (Mar 31, 2003)

### SUMMARY

The present disclosure has been devised to solve the above-described problems, and provides a refrigerator capable of increasing an inner volume of a refrigerating compartment by reducing an area protruding inwardly of the refrigerating compartment without the need to install a separate suction fan in the refrigerating compartment for deodorization of the refrigerating compartment.

In addition, a purpose of the present disclosure is to provide a structure in which a user may easily remove the filter assembly in a storage compartment and replace the filter, thereby improving the convenience of use.

In addition, another purpose of the present disclosure is to enable a user outside the refrigerator to visually check whether a filter is mounted or not without removing the filter assembly, thereby improving the convenience of use.

Still another purpose of the present disclosure is to provide a method for providing the remaining service life of the deodorizing filter using visual or auditory information to a user so that the storage compartment of the refrigerator may be always kept clean.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

The present disclosure may be applied to a refrigerator, a kimchi refrigerator, or a warming cabinet.

The refrigerator of the present disclosure removes odors using a deodorizing filter inserted into a circulation duct for transporting cold air in order to maximize a storage space in a storage compartment.

The deodorizing filter is installed in front of a cold air discharge hole through which cold air is discharged.

The deodorizing filter is installed inside a cold air guide that serves to guide the cold air supplied from the cold air discharge hole to the storage compartment.

The cold air guide may have a lower end hinge-coupled to a lower end of a filter fixing portion coupled to a refrigerating compartment cold-air supply duct such that an upper end of the cold air guide pivots around the lower end thereof to close or open a filter mounting portion.

In addition, the cold air guide pivoting around the lower end thereof and the upper end of the filter fixing portion are coupled to each other in a hooked manner, so that the user may easily release the coupling therebetween by pressing the hook.

The filter is fixedly received in the filter casing which in turn passes through an opening defined in the upper end of the cold air guide and is inserted into the cold air guide.

A display indicating that the filter is installed in the cold air guide may protrude upwardly through the opening defined in the upper end of the filter casing so as to be exposed to the outside.

The user may check whether the filter is mounted based on the presence or absence of the display.

A magnet is installed at a vertical level corresponding to a lower end of the display and is disposed on the upper end of the filter casing.

A reed sensor is installed on the refrigerating compartment cold-air supply duct at a position facing the magnet.

The reed sensor may measure the presence or absence of the magnet and check whether the filter is mounted based on a measurement signal indicating presence or absence of the magnet.

The measurement information from the reed sensor is transmitted to a printed circuit board (PCB).

The PCB transmits the information to a display or speaker installed on one side of the refrigerator so that the user may check whether the filter is mounted based on the information output from the display or the speaker.

In addition, the PCB may calculate the remaining service life of the filter based on the time at which the filter was installed and notify the user of the calculated service life.

When the filter is not installed or the filter service life has expired, this situation may be transmitted to the user through the display or speaker.

In order to achieve the above-described purpose, one aspect of the present disclosure provides a refrigerator comprising: a refrigerator compartment cold-air supply duct installed on one side surface of the refrigerator compartment and configured to receive cold air generated from an evaporator via a connection duct; a filter mounting portion disposed on one side surface of the refrigerating compartment cold-air supply duct and defined by a protruding edge; a pair of filter fixing portions disposed in an inner area of the filter mounting portion and spaced from each other; a pair of cold air guide fixing portions spaced from each other and rotatably coupled to the pair of filter fixing portions, respectively, and fixed to the filter mounting portion; a cold air guide having a lower end hinge-coupled to lower ends of the pair of cold air guide fixing portions, wherein an opening is defined in the upper end of the cold air guide, wherein a pair of filter casing fixing portions are disposed on an inner side surface of the cold air guide and are integrally formed therewith; and a filter casing configured to receive therein a refrigerator compartment filter, wherein the filter casing is configured to pass through the opening so as to be inserted into the cold air guide and into a space defined between the pair of filter casing fixing portions, and to pass through the opening so as to be removed from the cold air guide.

In accordance with some embodiments of the refrigerator, the hinge-coupling is achieved such that protrusions respectively formed on both opposing sides of the lower end of the cold air guide are respectively inserted into hinge grooves respectively defined in the lower ends of the pair of cold air guide fixing portions.

In accordance with some embodiments of the refrigerator, a display is disposed on an upper end of the filter casing and extends upwardly from the upper end thereof.

In accordance with some embodiments of the refrigerator, fixing protrusions are respectively formed on both opposing side ends of an upper surface of the cold air guide, wherein fixing openings are respectively defined at upper ends of the pair of cold air guide fixing portions, wherein the fixing protrusions are elastically coupled to the fixing openings such that that the cold air guide is coupled to the pair of cold air guide fixing portions.

In accordance with some embodiments of the refrigerator, when the cold air guide is coupled to the pair of cold air guide fixing portions, a refrigerating compartment cold-air auxiliary discharge hole is formed in one side surface of the refrigerating compartment cold-air supply duct facing the refrigerating compartment filter, wherein cold air is supplied through the refrigerating compartment cold-air auxiliary discharge hole to the refrigerating compartment.

In accordance with some embodiments of the refrigerator, a magnet receiving portion is disposed on the upper end of the filter casing and is positioned at a vertical level corresponding to a lower end of the display, wherein a magnet is inserted into and installed in the magnet receiving portion.

In accordance with some embodiments of the refrigerator, the refrigerating compartment cold-air supply duct includes: a duct body defining a front surface shape thereof; a duct sheet spaced apart from the duct body and disposed in rear of the duct body; and a duct thermal insulation portion provided between the duct body and the duct sheet and configured to have a first refrigerating compartment cold-air flow path and a second refrigerating compartment cold-air flow path defined therein, wherein along the first refrigerating compartment cold-air flow path and the second refrigerating compartment cold-air flow path, the cold air is supplied to the refrigerating compartment.

In accordance with some embodiments of the refrigerator, a reed sensor configured to sense whether the magnet is mounted is installed on the duct body and at a position of the duct body facing the magnet when the cold air guide and the cold air guide fixing portions are fastened to each other.

In accordance with some embodiments of the refrigerator, the reed sensor is installed in a separate space insulated from cold air or moisture.

In accordance with some embodiments of the refrigerator, the refrigerator comprises a printed circuit board (PCB) configured to determine display whether the refrigerating compartment filter is mounted or not and a replacement time of the refrigerating compartment filter based on measurement information from the reed sensor and to display whether the refrigerating compartment filter is mounted or not and the replacement time of the refrigerating compartment filter on a display installed on one side of the refrigerator.

In accordance with some embodiments of the refrigerator, the PCB is installed on a rear surface of an inner casing facing the duct sheet.

In accordance with some embodiments of the refrigerator, the measurement information from the reed sensor is transmitted to the PCB via a wire, wherein the wire passes through a first through hole and a second through hole respectively formed in an upper end of the duct thermal insulation portion and an upper end of the duct sheet and is connected to the reed sensor.

In order to achieve the above-described purpose, another aspect of the present disclosure provides a filter assembly comprising: a cold air discharge hole configured to discharge cold air to a refrigerating compartment; a filter mounting portion defined by a protruding edge extending so as to surround the cold air discharge hole; a pair of cold air guide fixing portions detachably coupled to the filter mounting portion; a cold air guide having a lower end hinge-coupled to lower ends of the pair of cold air guide fixing portions such that an upper end of the cold air guide pivots around the lower end thereof so as to close or open the filter mounting portion, wherein an opening is defined in an upper end of the cold air guide; and a filter casing configured to pass through the opening so as to be inserted into the cold air guide or be removed from the cold air guide, wherein a display is installed on an upper end of the filter casing, wherein the filter casing is received in the cold air guide and is fixedly disposed in a central area of the cold air guide; and a refrigerating compartment filter inserted into the filter casing and configured to filter the cold air to be supplied to the cold air discharge hole.

In accordance with some embodiments of the filter assembly, in a state in which the filter casing has been fully inserted into the cold air guide, the display protrudes upwardly through the opening so as to be exposed to an outside out of the cold air guide.

In accordance with some embodiments of the filter assembly, a magnet receiving portion is disposed on the upper end of the filter casing and is positioned at a vertical level corresponding to a lower end of the display, wherein a magnet is inserted into and installed in the magnet receiving portion.

In accordance with some embodiments of the filter assembly, the cold air discharge hole is defined in a refrigerating compartment cold-air supply duct configured to transmit the cold air generated from an evaporator, wherein a reed sensor configured to detect whether the magnet is mounted is installed at a position of the refrigerating compartment cold-air supply duct facing the magnet.

In accordance with some embodiments of the filter assembly, a pair of filter casing fixing portions are disposed on an inner side surface of the cold air guide and configured to secure both opposing side surfaces of the filter casing.

In accordance with some embodiments of the filter assembly, a protrusion is formed on one side of each of the filter casing fixing portion so as to secure a front surface and a rear surface of the filter casing.

In accordance with some embodiments of the filter assembly, fixing protrusions are respectively formed on both opposing side ends around the opening of an upper surface of the cold air guide, wherein fixing openings are respectively defined at upper ends of the pair of cold air guide fixing portions, wherein the fixing protrusions are elastically coupled to the fixing openings such that that the cold air guide is coupled to the pair of cold air guide fixing portions.

In accordance with some embodiments of the filter assembly, each of a pair of support portions is disposed inwardly of each of the cold air guide fixing portions, wherein an upper connection portion connects each of the cold air guide fixing portions and each of the pair of support portions to each other, wherein a pivot movement guide portion is formed on one side of each of the support portions.

In accordance with some embodiments of the filter assembly, the pivot movement guide portion is rotatably fastened to a filter fixing portion formed between the cold air discharge hole and the protruding edge defining the filter mounting portion.

In accordance with some embodiments of the filter assembly, the reed sensor is installed on at least one of a duct body or a duct thermal insulation portion of the refrigerating compartment cold-air supply duct, wherein the reed sensor is disposed in a separate thermally insulated space.

Specific matters of other embodiments are included in specific contents and drawings for carrying out the present disclosure.

According to the present disclosure, since the refrigerator according to the present disclosure may deodorize the refrigerator compartment using the refrigerator compartment cold-air auxiliary flow path branched from the refrigerator compartment cold-air flow path for supplying the cold air to the refrigerator compartment, there is no need to install a separate suction fan in the refrigerator compartment for deodorizing the refrigerator compartment.

Accordingly, the area protruding toward the inside of the refrigerating compartment may be reduced due to the absence of the suction fan, such that the inner volume of the refrigerating compartment may be increased, and the deodorization function of the refrigerating compartment may be performed without interfering with the air flow of the cold air supplied to and circulated in the refrigerating compartment.

According to the present disclosure, the user may simply press the portion of the cooling air guide in which the refrigerating compartment filter is installed such that the upper end of the cold air guide pivots downwardly and thus is removed from the duct. Thus, a user may perform filter exchange by means of his/her own power.

According to the present disclosure, the display protrudes upwardly through the opening defined in the upper end of the cold air guide so as to be exposed to the outside, such that the user outside the refrigerator may check whether the filter is mounted without disassembling the filter assembly.

In addition, the reed sensor responding to the magnet mounted on the filter casing may be installed and the sensing information thereof may be sent to the display installed on one side of the refrigerator and thus the user may easily check whether the filter is mounted.

In addition, the reed sensor is installed in a separate thermally insulated space. Thus, the reed sensor may be protected from cold air of the refrigerator to secure reliability of a measurement value and extend a service life thereof.

In addition, the PCB may receive the measurement signal from the reed sensor and may calculate the remaining service life of the filter based on the received measurement signal and provide the same to the user.

According to the present disclosure, the filter for deodorizing the refrigerator is effectively maintained, so that the refrigerator is always kept clean.

In addition to the above-described effects, specific effects of the present disclosure will be described together while describing specific matters for implementing the present disclosure.

### BRIEF DESCRIPTION OF DRAWINGS

FIG. 1 is a front perspective view illustrating a state in which a door of a refrigerator is opened.

FIG. 2 is a front perspective view of a refrigerator in which a display is installed inside the refrigerator.

FIGS. 3 and 4 are a front perspective view and a rear perspective view of a duct assembly for flowing cold air in a refrigerator and a casing of the refrigerator.

FIG. 5 is a rear perspective view of a state in which various ducts and grill fan assemblies are coupled to each other.

FIG. 6 is a front view of a refrigerator including a grill fan assembly and a refrigerating compartment cold-air supply duct and showing the inside of refrigerator through the refrigerator.

FIG. 7 is a front perspective view showing a cold air circulation structure of a refrigerating compartment.

FIG. 8 is an exploded rear perspective view of some components of a refrigerating compartment cold-air supply duct receiving therein a refrigerating compartment filter.

FIG. 9 is a front perspective view of the refrigerating compartment cold-air supply duct.

FIG. 10 is a front view illustrating a cold air auxiliary discharge hole of a refrigerating compartment.

FIGS. 11A and 11B are front views illustrating a method in which a refrigerating compartment filter is attached to and detached from a refrigerating compartment in a conventional refrigerator.

FIG. 12 is a front perspective view illustrating that a refrigerating compartment filter is mounted into a refrigerating compartment according to the present disclosure.

FIG. 13 is a rear perspective view illustrating a structure of a cold air guide fixing a refrigerating compartment filter and a cold air guide fixing portion fixing the cold air guide in accordance with the present disclosure.

FIG. 14 is a side view illustrating a structure in which the cold air guide and the cold air guide fixing portion are fastened to and detached from each other in accordance with the present disclosure.

FIG. 15 is a front perspective view of a state in which a filter casing is inserted into and installed inside the cold air guide in accordance with the present disclosure.

FIG. 16 is an exploded front perspective view of a refrigerating compartment cold-air supply duct for illustrating a position where each of a filter casing and a reed sensor is disposed in accordance with the present disclosure.

FIGS. 17A and 17B are front and side perspective views showing that the reed sensor is installed in an insulated manner from in the refrigerating compartment cold-air flow path in accordance with the present disclosure.

FIG. 18 is an exploded rear perspective view of a refrigerator compartment cold-air supply duct for illustrating a connection path along which the reed sensor is connected to a PCB in accordance with the present disclosure.

### DETAILED DESCRIPTIONS

Hereinafter, preferred embodiments of the present disclosure will be described in detail with reference to the accompanying drawings.

The present disclosure will be described in detail, based on contents necessary to allow the skilled person to that art to understand the operation and effect according to the present disclosure.

While describing an embodiment of the present disclosure, descriptions of technical contents well known in the technical field to which the present disclosure pertains and not directly related to the present disclosure will be omitted.

This is to omit unnecessary descriptions to more clearly convey the gist of the present disclosure without making the gist of the present disclosure unclear.

In addition, in describing the components of the present disclosure, different reference numerals may be assigned to the component having the same name according to the drawings, or the same reference numerals may be assigned to the component across different drawings.

However, even in such a case, this does not mean that the component has different functions according to the embodiment or has the same function in different embodiments, and the function of each component should be determined based on the description of each component in each embodiment.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is directed to the purpose of describing particular embodiments only and is not intended to be limiting of the present disclosure. As used herein, the singular constitutes "a" and "an" are intended to include the plural constitutes as well, unless the context clearly indicates otherwise.

It will be further understood that the terms "comprise", "comprising", "include", and "including" when used in the present disclosure, specify the presence of the stated features, integers, operations, elements, and/or components, but do not preclude the presence or addition of one or more other features, integers, operations, elements, components, and/or portions thereof.

The present disclosure is not limited to the embodiments disclosed below, but may be implemented in various different forms. The present embodiment is provided to make the present disclosure complete and to fully inform a person skilled in the art of the scope of the present disclosure.

Hereinafter, a refrigerator according to some embodiments of the present disclosure will be described.

### Basic Structure of Refrigerator

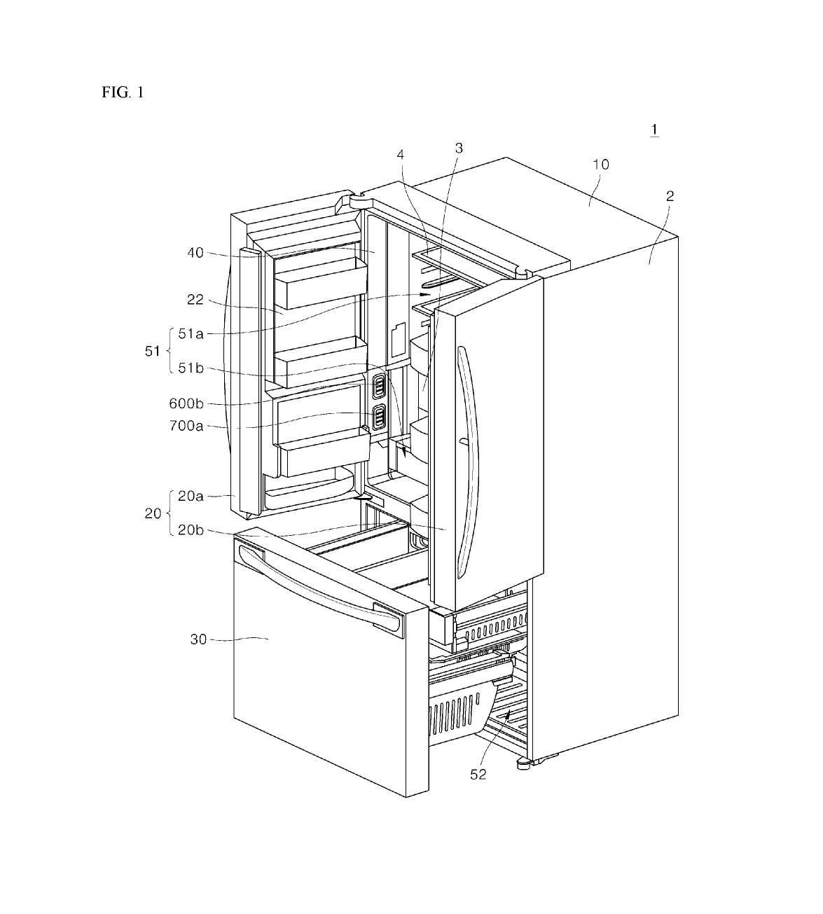

FIG. 1 illustrates an embodiment of a refrigerator described in the present disclosure.

A refrigerator 1 may have an outer appearance defined by a cabinet 2 having a storage space defined therein and a door capable of opening and closing an opened front surface of the cabinet 2.

The cabinet 2 may include an outer casing 10 defining an outer surface of the refrigerator 1 and an inner casing 40 defining an inner surface thereof.

The outer casing 10 and the inner casing 40 may be spaced apart from each other so as to have a space defined therebetween. An thermal insulating material may fill the space defined therebetween. The thermal insulating material may include a foam.

The storage space defined in the cabinet 2 may be divided into a plurality of spaces which may include a refrigerating compartment 51 and a freezing compartment 52.

In the present disclosure, an example in which the freezing compartment 52 is disposed in a lower space of the cabinet 2 and the refrigerating compartment 51 is disposed in an upper space thereof will be described.

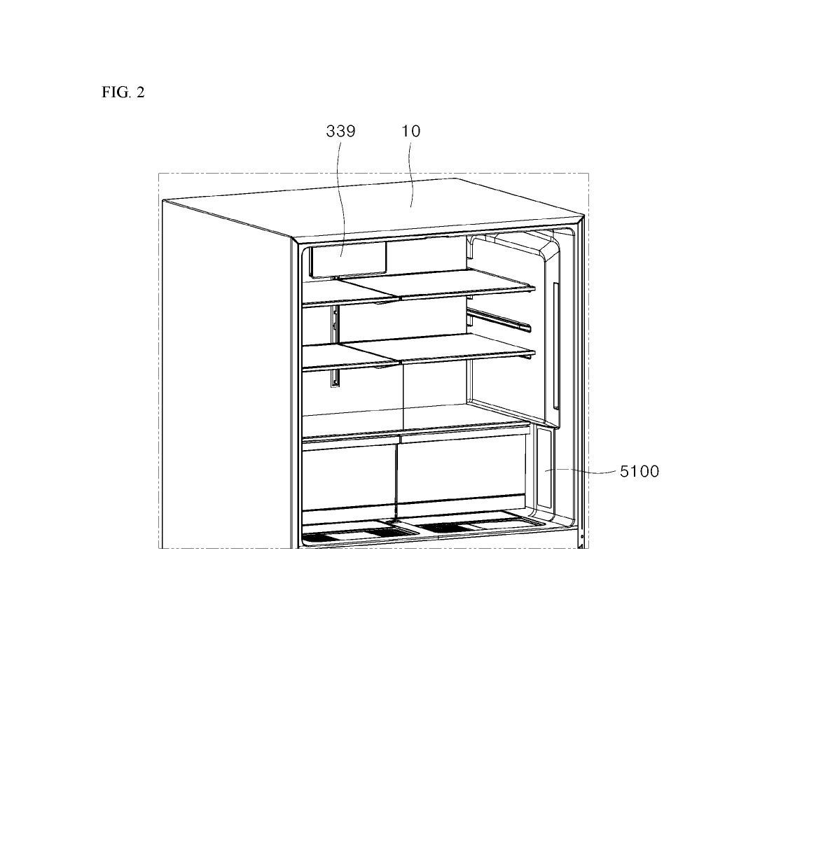

FIG. 2 illustrates one embodiment of one side of an inside of the refrigerator 1.

A display 5100 may be installed on one side of the refrigerating compartment 51 of the refrigerator 1.

The display 5100 may be installed on an inner surface or an outer surface of the refrigerator.

The display 5100 may serve to transmit an operation state of the refrigerator or notifications to the user.

For example, the display 5100 may display a temperature of each of the refrigerating compartment 51 and the freezing compartment 52 of the refrigerator, whether a refrigerating compartment filter 331 is mounted, a remaining service life, etc.

In addition, although not shown, a speaker for transmitting information to a user may be installed on one side of the refrigerator 1.

When the user does not check the display 5100, the speaker may transmit a notification sound or an alarm sound to guide the user to check the operation status of the refrigerator.

### Cold Air Flow Path in Refrigerator

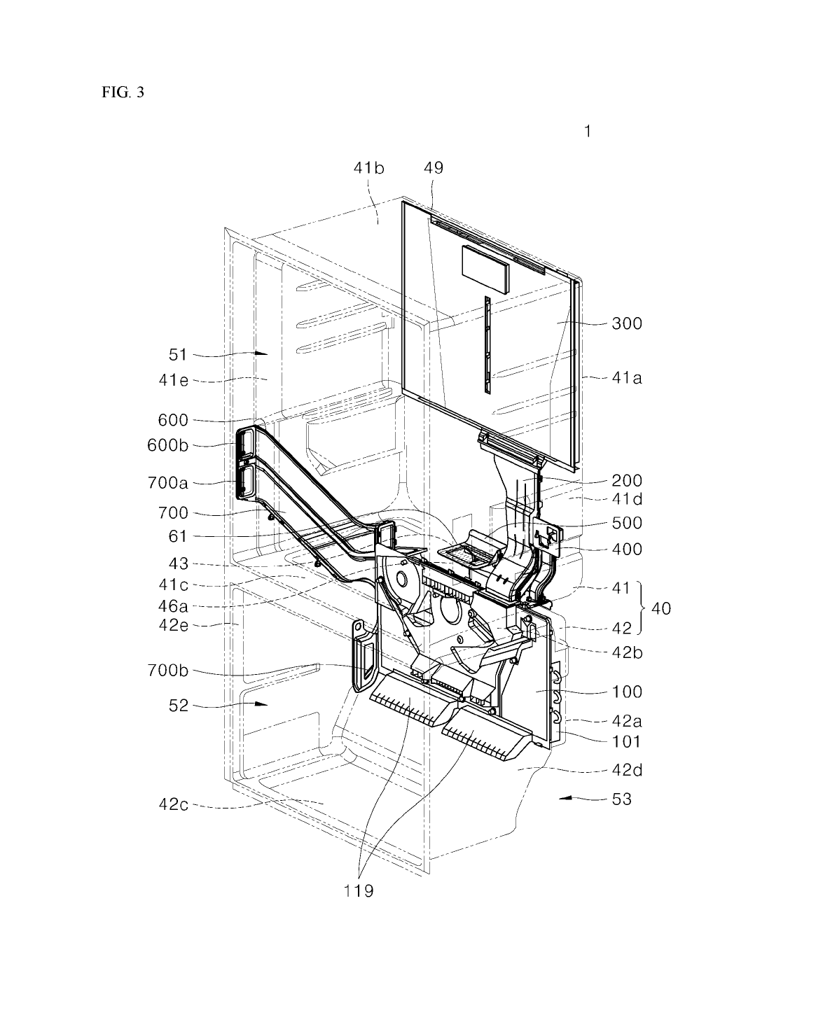

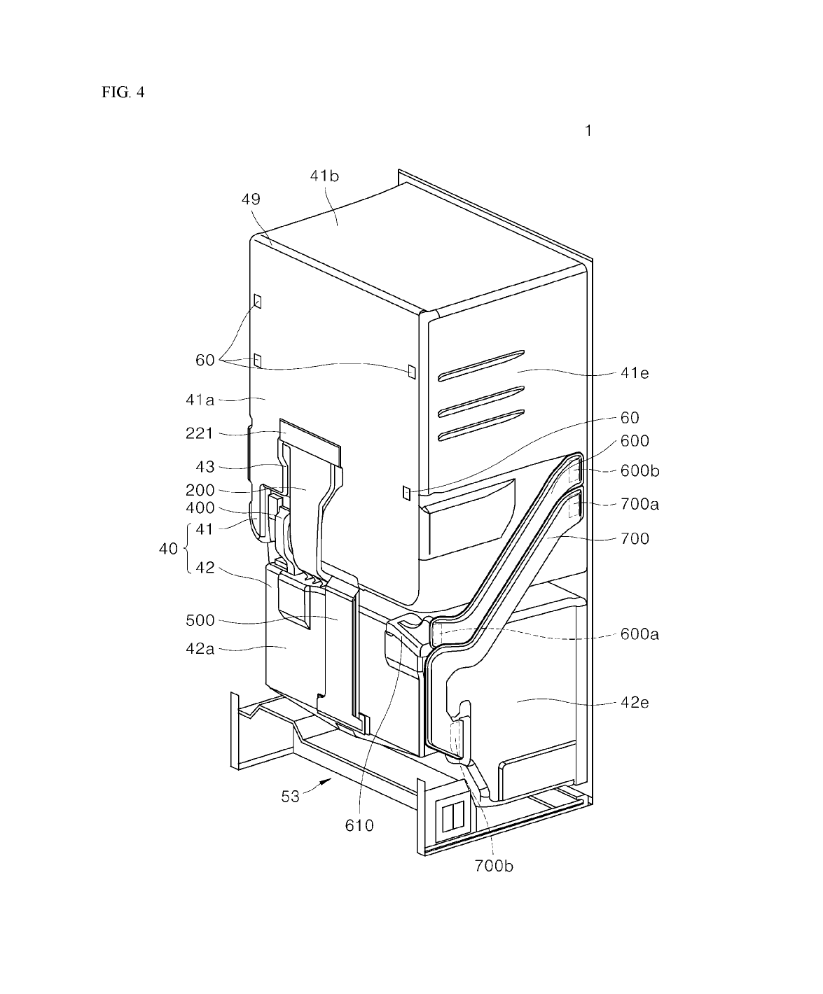

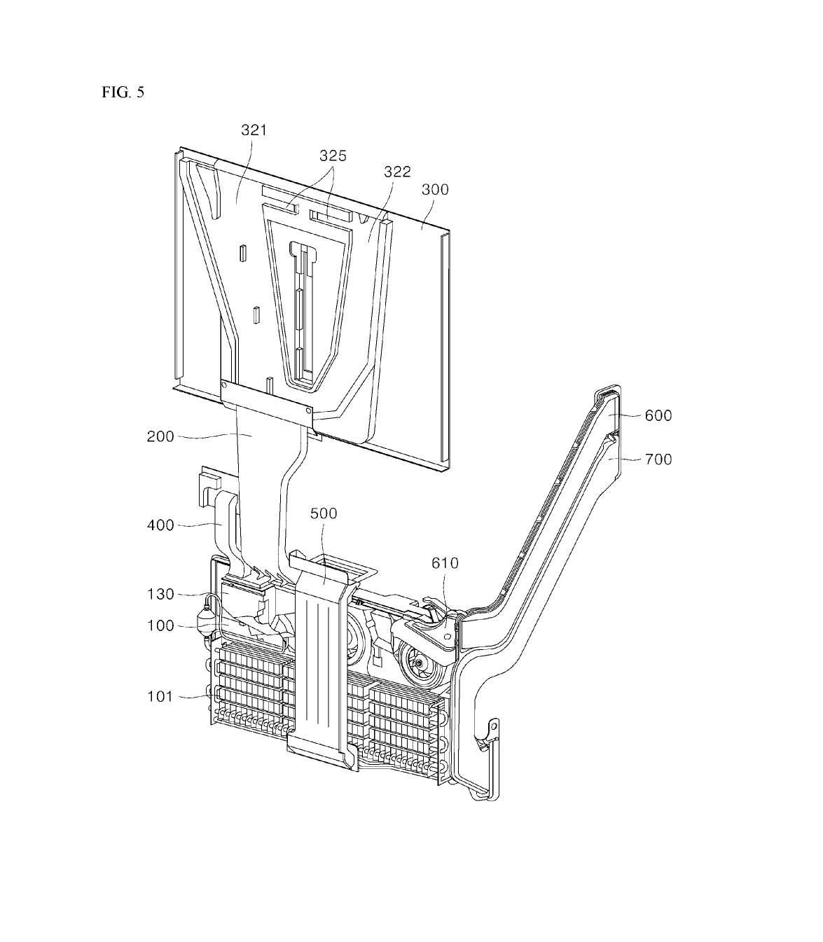

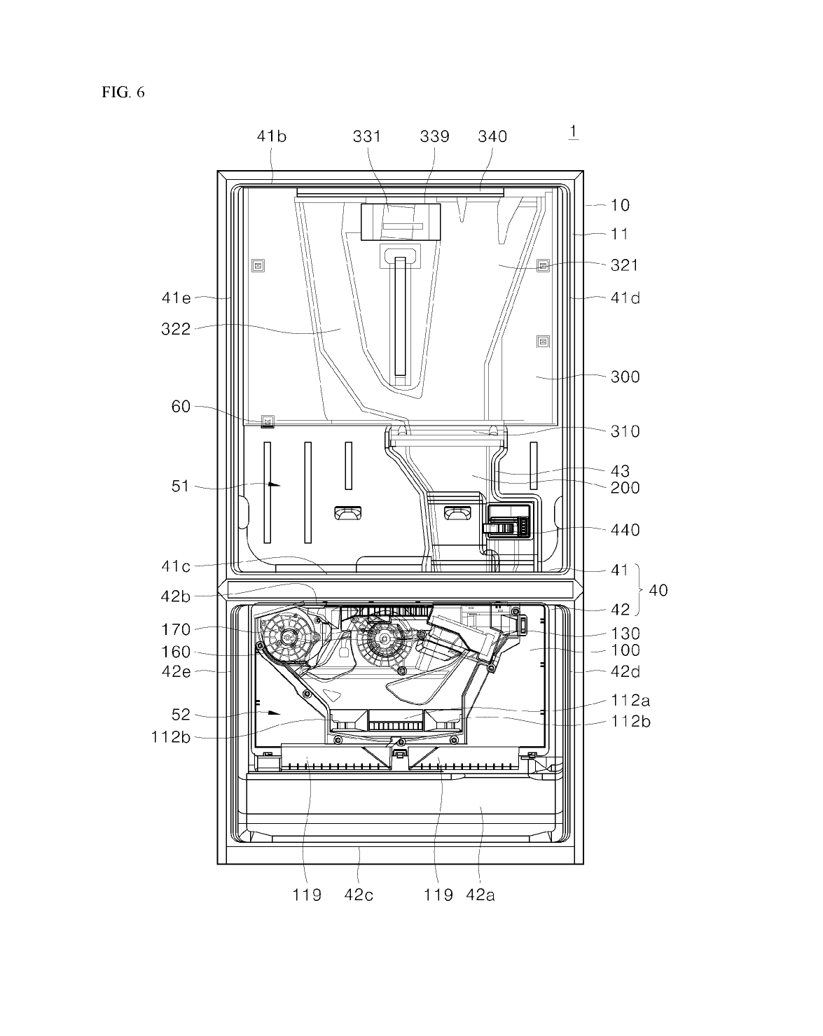

Hereinafter, a cold air supply system of the refrigerator 1 and a connection relationship between respective components thereof will be described with reference to FIGS. 3 to 7.

The refrigerator shown in the drawings corresponds to an embodiment of the present disclosure, and the scope of the present disclosure is not limited by the drawings.

The inner casing 40 may be partitioned to include a refrigerating casing 41 disposed in an upper area to define the refrigerating compartment 51 and a freezing casing 42 disposed in a lower area to define the freezing compartment 52.

Cold air generated from one evaporator 101 may be supplied to both the refrigerating compartment 51 and the freezing compartment 52.

When an ice making compartment 22 is additionally provided in an upper door 20 of the refrigerator 1, cold air generated from one evaporator 101 may be supplied to all of the refrigerating compartment 51, the freezing compartment 52, and the ice making compartment 22.

The evaporator 101 for generating the cold air may be disposed in the freezing compartment 52, and specifically, may be disposed inside the freezing casing 42 and on a rear surface 42a of the freezing casing 42.

The evaporator 101 may be located on top of a machine room 53.

The machine room 53 may be provided in an area corresponding to a lower area of the freezing casing 42 and be disposed in rear thereof, and may provide a space in which a compressor 54 and a condenser may be installed.

A lower rear space of the freezing compartment 52 may have a freezing space smaller than a freezing space of an upper rear space of the freezing compartment 52 by a space occupied with the machine room 53.

That is, an upper surface 42b of the freezing casing has a larger area size than that of a lower surface 42c of the freezing casing.

Accordingly, a rear side of an upper area of the freezing compartment 52 may protrude further rearwards beyond a rear side of a lower area of the freezing compartment 52. The evaporator 101 may be located in an upper rear space of the freezing compartment 52.

A grill fan assembly 100 for blowing the cold air generated from the evaporator 101 to the refrigerating compartment 51 and the freezing compartment 52 may be disposed on a front surface of the evaporator 101.

When the ice making compartment 22 is provided in the upper door 20 of the refrigerator 1, the cold air generated from one evaporator 101 may be blown from one grill fan assembly 100 to all of the refrigerating compartment 51, the freezing compartment 52, and the ice making compartment 22.

As described above, in the refrigerator 1 according to the present disclosure, the cold air generated from one evaporator 101 located in the freezing compartment 52 may be supplied not only to the freezing compartment 52 but also to the refrigerating compartment 51.

Therefore, a separate space in which the evaporator 101 is disposed does not need to be secured in the refrigerating compartment 51, such that a volume of the refrigerating compartment 51 may be increased.

In order to blow the cold air to a refrigerating compartment cold-air supply duct 300 that supplies the cold air to the refrigerating compartment 51, a connection duct 200 may be additionally disposed between the grill fan assembly 100 and the refrigerating compartment cold-air supply duct 300.

One end of the connection duct 200 may be connected to the grill fan assembly 100, and the other end of the connection duct 200 may be connected to the refrigerating compartment cold-air supply duct 300, so that the cold air blown from the grill fan assembly 100 may be guided to the refrigerating compartment cold-air supply duct 300.

The refrigerating compartment cold-air supply duct 300 may be disposed inside the refrigerating casing 41. The connection duct 200 may be disposed outside the refrigerating casing 41. The refrigerating compartment cold-air supply duct 300 and the connection duct 200 may communicate with each other at a rear surface 41a of the refrigerating casing 41.

An thermal insulation material 11 may fill the space between the inner casing 40 and the outer casing 10 and may include a foam.

The connection duct 200 may be disposed to pass through the space between the inner casing 40 and the outer casing 10 filled with the thermal insulating material 11 including the foam and may be buried in the space between the inner casing 40 and the outer casing 10.

Accordingly, when the upper door 20 of the refrigerator 1 is opened, the refrigerating compartment cold-air supply duct 300 disposed inside the refrigerating casing 41 may be exposed to the outside of the refrigerator, while the connection duct 200 disposed outside the refrigerating casing 41 may not be exposed to the outside of the refrigerator.

A rear protrusion 43 protruding from the rear surface 41a of the refrigerating casing inwardly of the refrigerating casing 41 may be positioned so that a space is defined between the rear protrusion 43 and the rear surface 41a and at least a partial area of the connection duct 200 is inserted from a position outside the refrigerating casing 41 into the space.

The space between the rear protrusion 43 and the rear surface 41a may be formed in a shape corresponding to a shape of the connection duct 200 so that the connection duct 200 may be inserted thereinto.

The space between the rear protrusion 43 and the rear surface 41a may have a shape extending along the rear surface 41a of the refrigerating casing 41 and in a direction from the lower surface 41c of the refrigerating casing to the upper surface 41b of the refrigerating casing 41.

Since the refrigerating compartment cold-air supply duct 300 is disposed inside the refrigerating casing 41, the volume of the inner space of the refrigerating casing 41 decreases as the area occupied with the refrigerating compartment cold-air supply duct 300 increases.

In particular, the refrigerating compartment cold-air supply duct 300 includes a cold air channel through which the cold air flows. Thus, when the cold air flows through the refrigerating compartment 51 in a relatively humid environment, dew forms. Thus, a thermal insulation member having a predetermined thickness is included.

Therefore, in order to increase the inner volume of the refrigerating casing 41, it is necessary to reduce the area occupied with the refrigerating compartment cold-air supply duct 300 disposed inside the refrigerating casing 41.

The refrigerating compartment cold-air supply duct 300 according to the present disclosure extends from the lower surface 41c of the refrigerating casing to the upper surface 41b of the refrigerating casing 41 and does not constitute the rear surface 41a of the refrigerating casing 41.

The space between the rear protrusion 43 and the rear surface 41a of the refrigerating casing 41 having the shape extending along the rear surface 41a of the refrigerating casing may extend in a predetermined vertical length in the direction from the lower surface 41c of the refrigerating casing to the upper surface 41b of the refrigerating casing 41.

Since the connection duct 200 is disposed on a rear surface of the rear protrusion 43, the connection duct 200 is disposed outside the refrigerating casing 41 rather than inside the refrigerating casing 41.

Accordingly, an additional area protruding into the inside of the refrigerating casing 41 may be reduced except for the rear protrusion 43 along a vertical length along which the space between the rear protrusion 43 and the rear surface 41a into which the connection duct 200 is inserted extends. Thus, the inner volume of the refrigerating casing 41 may be increased accordingly.

The rear protrusion 43 may extend to a vertical level approximate to a central point in the vertical direction of the refrigeration casing 41. However, the present disclosure is not limited thereto.

For example, the rear protrusion 43 may be formed to extend from the lower surface 41c of the refrigerating casing to a predefined vertical level such that the rear protrusion 43 may be screened with a storage drawer 3 disposed inside the refrigerated casing 41.

In addition, the rear protrusion 43 may also be screened with a second storage compartment 51b formed in a lower area of the refrigeration casing 41.

Accordingly, the rear protrusion 43 may be formed to extend from the lower surface 41c of the refrigerating casing to the predefined vertical level such that the rear protrusion may be screened with the second storage compartment 51b and the storage drawer 3 disposed on top of the second storage compartment 51b.

In addition, the connection duct 200 extends through and along the space between the inner casing 40 and the outer casing 10 filled with the thermal insulating material 11 including the foam. Thus, an additional thermal insulating member for preventing heat exchange between the connection duct 200 through which the cold air flows and the refrigerating compartment 51 may not be required.

In order to provide the thermal insulation effect to the refrigerator 1, the thermal insulation material 11 having a very low thermal conductivity and including the foam may be disposed between the inner casing 40 and the outer casing 10 so as to fill the space between the inner casing 40 and the outer casing 10.

If the connection duct 200 is disposed inside the refrigeration casing 41, the connection duct 200 may include a thermal insulating member having a predetermined thickness and be thermally insulated.

However, as in an embodiment of the present disclosure, the connection duct 200 may be buried in and pass through the space between the inner casing 40 and the outer casing 10 filled with the thermal insulating material 11 including the foam.

Therefore, according to an embodiment of the present disclosure, a sufficient thermal insulation effect may be provided using the existing thermal insulation material 11 including the foam and disposed between the inner casing 40 and the outer casing 10 without the need to add a separate thermal insulation member for thermally insulating the connection duct 200.

As a result, according to an embodiment of the present disclosure, a separate thermal insulation member for providing a thermal insulation effect to the connection duct 200 is not additionally required, and thus the thickness of the connection duct 200 may be greatly reduced.

Accordingly, a thickness of the rear protrusion 43 protruding inwardly of the refrigerating casing 41 may be greatly reduced, thereby increasing the inner volume of the refrigerating compartment 51.

Accordingly, in the refrigerator 1 according to an embodiment of the present disclosure, the connection duct 200 and the refrigerating compartment cold-air supply duct 300 may communicate with each other at the rear surface of the refrigerating casing 41 while the refrigerating casing 41 is interposed therebetween, thereby reducing an area occupied with the refrigerating compartment cold-air supply duct 300 disposed inside the refrigerating casing 41 and on the rear surface 41a thereof.

Accordingly, the refrigerator 1 according to an embodiment of the present disclosure may greatly increase the inner volume of the refrigerating compartment 51.

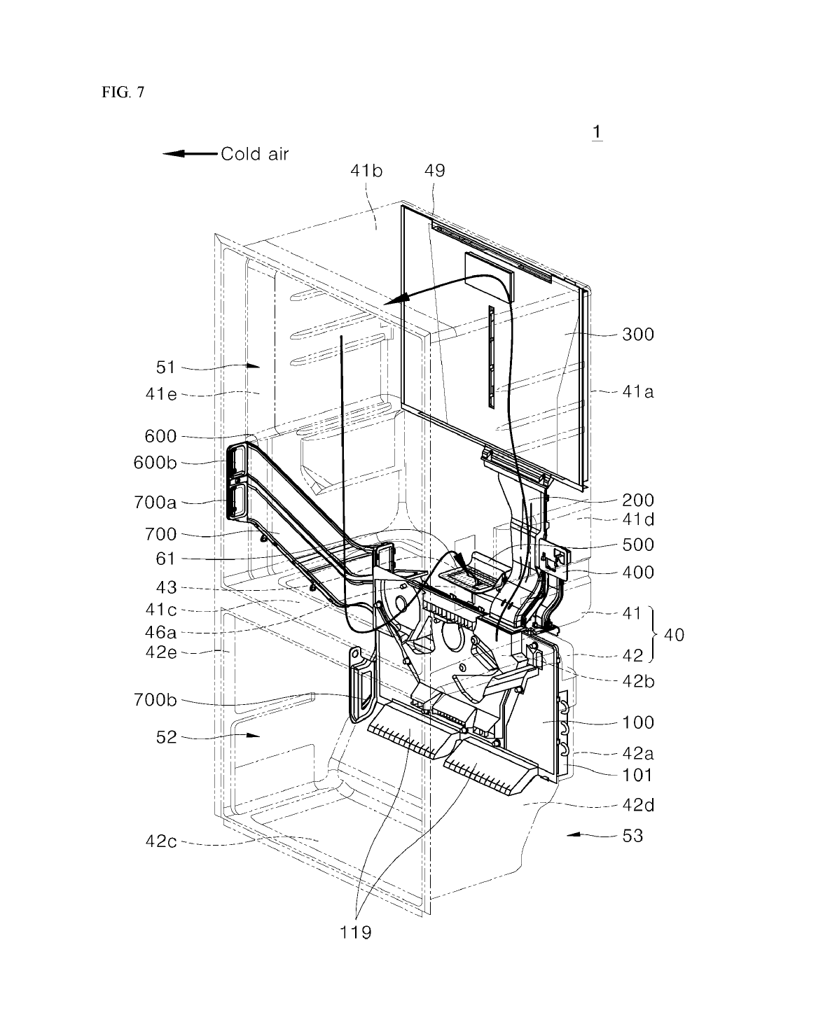

Using the cold air flow path communication structure as shown in FIG. 7, the cold air generated from the evaporator 101 may be supplied from the freezing compartment 52 to the refrigerating compartment 51.

In one example, a duct receiving groove 49 into which a portion of an upper area of the refrigerating compartment cold-air supply duct 300 is fixedly inserted may be defined in the upper surface 41b of the refrigerating casing 41.

The duct receiving groove 49 may extend along an area where the upper surface 41b of the refrigerating casing 41 and the rear surface 41a of the refrigerating casing 41 meet each other.

The duct receiving groove 49 may be formed in a form of a protrusion protruding upwardly when being viewed from a position on top of the upper surface 41b of the refrigerating casing, and may be formed in a form of a concave portion recessed upwardly when being viewed from a position under the upper surface 41b of the refrigerating casing 41.

A width of the duct receiving groove 49 in the front-rearward direction is slightly larger than a width of the upper area of the refrigerating compartment cold-air supply duct 300 in the front-rearward direction, so that the upper area of the refrigerating compartment cold-air supply duct 300 may be easily inserted into and fixed to the duct receiving groove 49.

The upper area of the refrigerating compartment cold-air supply duct 300 may be inserted into the duct receiving groove 49 so that the refrigerating compartment cold-air supply duct 300 and the refrigerating casing 41 are in surface-contact with each other, and thus are firmly fastened to each other.

The refrigerator 1 according to the present disclosure as described above may have a cold air circulation flow as shown in FIG. 7.

The cold air generated from the evaporator 101 disposed in the freezing compartment 52 may be blown to the connection duct 200 buried in the thermal insulating material 11 and disposed outside the rear surface of the refrigerating compartment 51 under the operation of the grill fan assembly 100 disposed in the freezing compartment 52.

The cold air blown to the connection duct 200 may communicate with the air contained in the refrigerating compartment cold-air supply duct 300 disposed inside the refrigerating compartment 51 and on the rear surface thereof at the rear surface of the refrigerating compartment 51 and may be guided to the refrigerating compartment cold-air supply duct 300.

The refrigerating compartment cold-air supply duct 300 may discharge the cold air in the frontward direction in the upper area of the refrigerating compartment 51.

The cold air discharged in the frontward direction in the upper area of the refrigerating compartment 51 circulates through the refrigerating compartment 51 and returns toward the rear surface of the refrigerating compartment 51 in the lower area of the refrigerating compartment 51.

A refrigerating compartment cold-air collection duct 500 communicates with a lower portion of an area located in rear of the refrigerating compartment 51. Thus, the cold air circulating in the refrigerating compartment 51 may be collected into the freezing compartment 52 through the refrigerating compartment cold-air collection duct 500.

The cold air generated from the evaporator 101 disposed in the freezing compartment 52 may be blown to a second storage compartment cold-air supply duct 400 buried in the thermal insulting material and disposed outside the refrigerating compartment 51 and on the rear surface of the refrigerating compartment 51 under the operation of the grill fan assembly 100 disposed in the freezing compartment 52.

Upon receiving the cold air blown thereto, the second storage compartment cold-air supply duct 400 may discharge the cold air from the rear surface of the refrigerating compartment 51 to the second storage compartment 51b.

The second storage compartment cold-air supply duct 400 may discharge the air in the frontward direction in an upper area of the second storage compartment 51b.

The cold air discharged in the frontward direction in the upper area of the second storage compartment 51b circulates through the second storage compartment 51b and then returns toward the rear surface of the second storage compartment 51b in the lower area of the second storage compartment 51b.

The refrigerating compartment cold-air collection duct 500 communicates with a lower portion of an area located in rear of the second storage compartment 51b. Thus, the cold air circulating in the second storage compartment 51b may be collected to the freezing compartment 52 through the refrigerating compartment cold-air collection duct 500.

As described above, the cold-air supply ducts for supplying the cold air to the first storage compartment 51a and the second storage compartment 51b, respectively are different from each other. However, the cold air circulating through the first storage compartment 51a and the cold air circulating through the second storage compartment 51b may be collected to the cold-air collection duct 500 of the refrigerating compartment as the common cold-air collection duct.

### Refrigerating Compartment Cold-Air Supply Duct

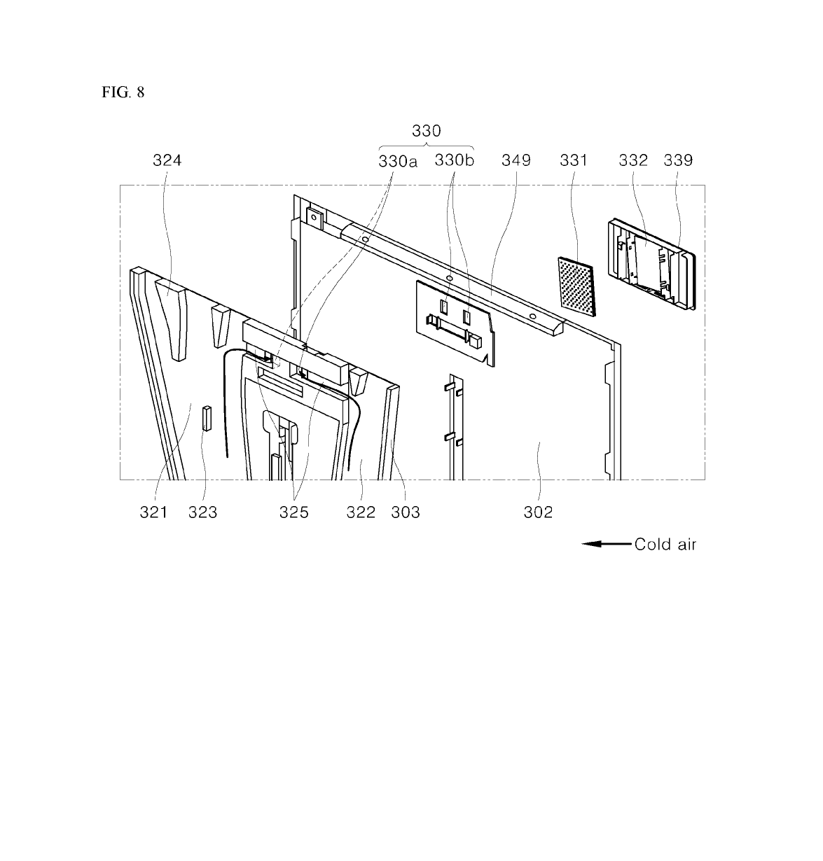

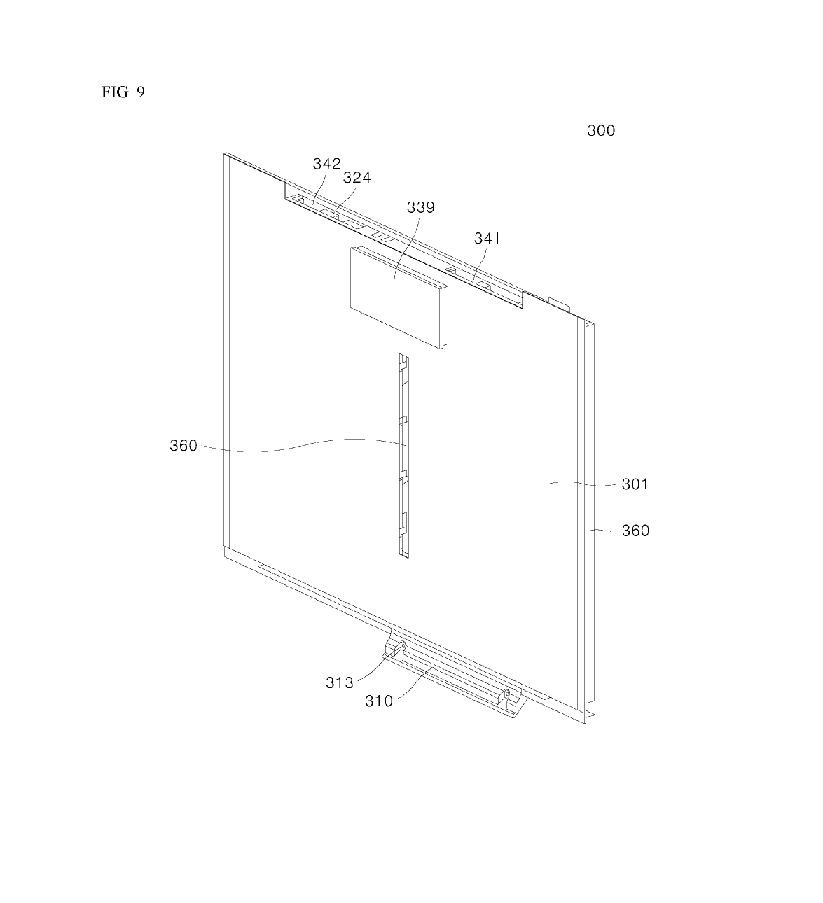

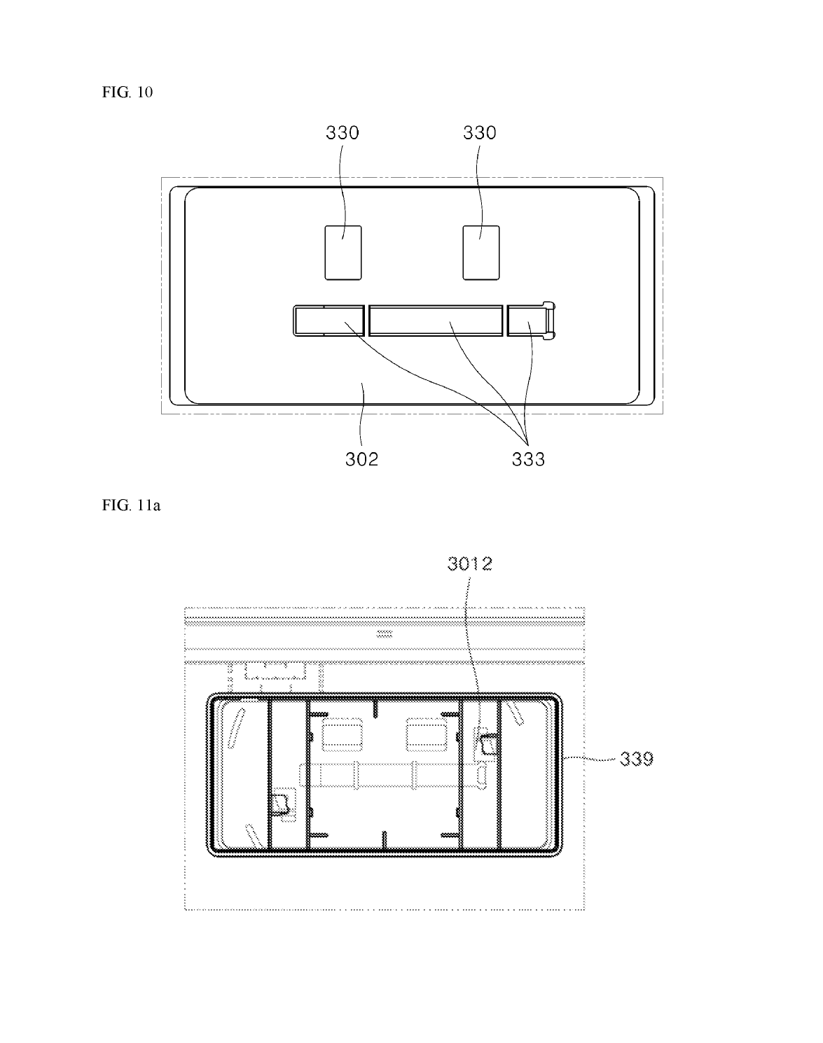

Hereinafter, the refrigerating compartment cold-air supply duct 300 will be described in more detail with reference to FIGS. 8 to 10.

The refrigerating compartment cold-air supply duct 300 may include a duct body 302 defining a front surface shape thereof, a duct sheet 304 spaced apart from the duct body 302 and disposed in rear of the duct body 302, and a duct thermal insulation portion 303 provided between the duct body 302 and the duct sheet 304 and configured to define a first refrigerating compartment cold-air flow path 321 and a second refrigerating compartment cold-air flow path 322.

A decoration panel 301 may be provided on a front surface of the duct body 302.

The decoration panel 301 may define the exterior of the rear wall surface of the first storage compartment 51a, and may be made of a metal material such as stainless steel.

A shelf fixing portion 309 may be formed on a central area of the decoration panel 301 and extend in a vertical direction.

A through hole corresponding to the shelf fixing portion 309 may be formed in each of the duct body 302, the duct thermal insulating portion 303, and the duct sheet 304 disposed on the rear surface of the decoration panel 301.

The duct body 302 may be formed in a size and shape corresponding to those of the rear surface 41a of the refrigerating casing 41.

In this regard, the duct body 302 may be formed to have a width in the left-right direction smaller than the width of the rear surface 41a of the refrigerating casing 41 in the left-right direction such that a predetermined spacing is defined between the duct body 302 and each of one side surface 41d of the refrigerating casing 41 and the other side surface 41e of the refrigerating casing.

Accordingly, the duct body 302 may not be in contact with the one side surface 41d of the refrigerating casing 41 and the other side surface 41e of the refrigerating casing 41.

A pair of lighting units 360 extending along the longitudinal direction of the duct body 302 may be respectively disposed on both opposing sides of the rear surface of the duct body 302.

The pair of lighting units 360 may be disposed to face the one side surface 41d of the refrigerating casing 41 and the other side surface 41e of the refrigerating casing, respectively, so that light beams from the pair of lighting units 360 are irradiated toward the one side surface 41d of the refrigerating casing 41 and the other side surface 41e of the refrigerating casing 41, respectively.

The lighting units 360 may be fastened and fixed to the duct body 302 using lighting unit fixing members and lighting unit fastening members such as bolts respectively disposed on both opposing sides of the rear surface of the duct body 302.

The upper area of the refrigerating compartment cold-air supply duct 300 may be inserted into the duct receiving groove 49 formed in the upper surface 41b of the refrigerating casing 41 and fixed to the refrigerating casing 41.

A refrigerating compartment cold-air supply duct connection portion 310 which protrudes downwards may be formed on a bottom portion of the duct body 302.

A pair of fastening member through holes 313 may be formed in the refrigerating compartment cold-air supply duct connection portion 310. A connection duct fixing member may be formed on an upper surface of the connection duct 200.

As a fastening member such as a bolt passes through the fastening member through hole 313 and is coupled to the connection duct fixing member, the bottom portion of the refrigerating compartment cold-air supply duct 300 may be coupled and fixed to the connection duct 200.

A duct lower cover may be disposed under the refrigerating compartment cold-air supply duct connection portion 310. The refrigerating compartment cold-air supply duct connection portion 310 and the connection duct 200 may communicate with each other with the duct lower cover interposed therebetween.

In addition, a duct lower gasket may be disposed under the duct lower cover to improve sealing between the refrigerating compartment cold-air supply duct connection portion 310 and the connection duct 200.

A plurality of fixing bosses may be formed on the rear surface of the duct body 302.

A fastening through-hole may be formed in the rear surface 41a of the refrigerating casing 41 in a corresponding manner to each of the fixing bosses.

A separate fastening bush may be disposed on an outer surface of the refrigeration casing 41 and pass through the fastening through-hole and be fastened to the fixing boss.

Accordingly, the refrigerating compartment cold-air supply duct 300 may be fixed to the rear surface 41a of the refrigerating casing 41 with a strong coupling force via the coupling between the fixing boss and the fastening bush.

The duct thermal insulating portion 303 having a predetermined thickness may be disposed in rear of the duct body 302.

A cold air flow path defined by a protrusion pattern protruding in the rearward direction of the duct thermal insulating portion 303 may be formed in the duct thermal insulating portion 303.

In order to cover and seal the cold air flow path formed in the duct thermal insulating portion 303, the duct sheet 304 having a shape corresponding to that of the cold air flow path of the duct thermal insulating portion 303 may be coupled to the duct thermal insulating portion 303 and disposed in rear of the duct thermal insulating portion 303.

For example, the duct sheet 304 may be made of a thermal insulating material to reduce heat loss of the cold air flowing along the inside of each of the first refrigerating compartment cold-air flow path 321 and the second refrigerating compartment cold-air flow path 322.

In addition, the duct sheet 304 may be formed to have a small thickness as long as the duct sheet is able to seal the first refrigerating compartment cold-air flow path 321 and the second refrigerating compartment cold-air flow path 322, thereby reducing the overall thickness of the refrigerating compartment cold-air supply duct 300.

However, when the duct sheet 304 is formed to have the thickness as small as possible, the support force of the duct sheet 304 may be insufficient.

Accordingly, a plurality of cold air guide ribs 323 protruding in the rearward direction on a rear surface of the duct thermal insulating portion 303 so as to guide the cold air flow direction may support the duct sheet 304.

The first refrigerating compartment cold-air flow path 321 and the second refrigerating compartment cold-air flow path 322 may be formed in the refrigerating compartment cold-air supply duct 300 via the coupling structure between the duct thermal insulation portion 303 and the duct sheet 304.

At a bottom portion of the duct thermal insulation portion 303, the cold air flow path may be divided into the first refrigerating compartment cold-air flow path 321 and the second refrigerating compartment cold-air flow path 322.

The cold air flowing through the first refrigerating compartment cold-air flow path 321 and the cold air flowing through the second refrigerating compartment cold-air flow path 322 may be discharged from a top end of the duct thermal insulation portion 303 to the refrigerating compartment 51 through a first refrigerating compartment cold-air main discharge hole 341 and a second refrigerating compartment cold-air main discharge hole 342, respectively.

A refrigerating compartment cold-air guide 324 may be formed at the top end of the duct thermal insulation portion 303 from which the coir air is discharged through the first refrigerating compartment cold-air main discharge hole 342 and the second refrigerating compartment cold-air main discharge hole 341 to the refrigerating compartment 51. The refrigerating compartment cold-air guide 324 may allow the cold air discharged through each discharge hole to be uniformly discharged.

The refrigerating compartment cold-air guide 324 may be formed in the shape of an island and on the rear surface of the duct thermal insulation portion 303 and may be formed to have the same vertical length as that of the cold air guide rib 323.

A refrigerating compartment cold-air main discharge guide 349 may be formed at the top end of the duct body 302 and be configured to guide the cold air discharged from the first refrigerating compartment cold-air main discharge hole 341 and the second refrigerating compartment cold-air main discharge hole 342 to be discharged toward a front surface of the refrigerating compartment 51.

The refrigerating compartment cold-air main discharge guide 349 may guide the cold air to be discharged to the refrigerating compartment 51 in the frontward direction.

The first refrigerating compartment cold-air flow path 321 disposed closer to the one side surface 41d of the refrigerating casing 41 may be formed to have a width greater than that of the second refrigerating compartment cold-air flow path 322 disposed closer to the other side surface 41e of the refrigerating casing 41.

Accordingly, even when an ice making compartment cold-air supply duct 600 and an ice making compartment cold-air collection duct 700 are disposed along the other side surface 41e of the refrigerating casing 41, a greater amount of the cold air may flow to the first refrigerating compartment cold-air flow path 321, thereby balancing the cold air amount across an entire area of the refrigerator 1.

The duct thermal insulation portion 303 may include one or more refrigerating compartment cold-air auxiliary flow paths 325 branched from the first refrigerating compartment cold-air flow path 321 and/or the second refrigerating compartment cold-air flow path 322.

For example, an additional cold air flow path may be branched from the upper area of the first refrigerating compartment cold-air flow path 321 and/or the second refrigerating compartment cold-air flow path 322 so as to extend toward a center of the duct thermal insulating portion 303, thereby defining the refrigerating compartment cold-air auxiliary flow path 325.

In an embodiment of the present disclosure, a pair of additional cold air flow paths may be branched from the first refrigerating compartment cold-air flow path 321 and the second refrigerating compartment cold-air flow path 322, respectively, so that a pair of refrigerating compartment cold-air auxiliary flow paths 325 may be formed.

The duct thermal insulation portion 303 may include a refrigerating compartment cold-air auxiliary discharge hole 330 through which the cold air guided through the refrigerating compartment cold-air auxiliary flow path 325 is discharged.

Each refrigerating compartment cold-air auxiliary flow path 325 may be branched from each of the first refrigerating compartment cold-air flow path 321 and the second refrigerating compartment cold-air flow path 322 in an upper area on top of the center of the refrigerating compartment 51 so as to extend toward the center of the refrigerating compartment 51.

Accordingly, the refrigerating compartment cold-air auxiliary discharge hole 330 may be positioned on top of the center of the refrigerating compartment 51.

The refrigerating compartment cold-air auxiliary discharge hole 330 may be disposed under the first refrigerating compartment cold-air main discharge hole 341 and the second refrigerating compartment cold-air main discharge hole 342.

A cold air guide 339 including a refrigerating compartment filter 331 may be disposed in front of the refrigerating compartment cold-air auxiliary discharge hole 330.

The cold air supplied from the refrigerating compartment cold-air auxiliary discharge hole 330 may flow through the refrigerating compartment filter 331.

The refrigerating compartment cold-air auxiliary discharge hole 330 may include a first refrigerating compartment cold-air auxiliary discharge hole 330a and a second refrigerating compartment cold-air auxiliary discharge hole 330b.

The refrigerating compartment filter 331 may be a deodorizing filter including activated carbon or the like for removing odor.

As described above, in the refrigerator 1 according to the present disclosure, it is not necessary to install a separate suction fan in the refrigerating compartment 51 in order to deodorize the refrigerating compartment 51.

Accordingly, an area protruding into the inside of the refrigerating compartment 51 in which the suction fan is disposed may be reduced, such that the inner volume of the refrigerating compartment 51 may be increased.

In addition, for deodorization of the refrigerating compartment 51, the refrigerator 1 according to the present disclosure may use the refrigerating compartment cold-air auxiliary flow path 325 for discharging the cold air, instead of sucking the cold air of the refrigerating compartment 51 with a suction fan for deodorization.

Accordingly, a deodorization function of the refrigerating compartment may be performed without interfering with a circulation flow in which the cold air is supplied to and is circulated in the refrigerating compartment.

In addition, the refrigerator 1 according to the present disclosure may perform the deodorization function directly using the continuous cold air supply and circulation.

Accordingly, a total amount of the cold air flowing through the refrigerating compartment filter 331 may be similar or further increased, compared to that in a case of performing the deodorization function by intermittently operating the suction fan, thereby improving the deodorization effect.

The cold air guide 339 may further include a thermal insulating member 332 disposed in front of the refrigerating compartment filter 331.

The thermal insulating member 332 is disposed to be spaced apart from the refrigerating compartment filter 331, such that a cold air flow path through which the cold air flows may be formed between the thermal insulating member 332 and the refrigerating compartment filter 331.

The cold air guide 339 may guide the cold air having flowed through the refrigerating compartment filter 331 to flow through the separation space between the thermal insulating member 332 and the refrigerating compartment filter 331 and to be discharged downwardly of the refrigerating compartment 51.

Accordingly, the cold air guide 339 may have a shape screening the front surface of the refrigerating compartment cold-air auxiliary discharge hole 330. A cold air discharge hole through which the cold air may be discharged may be formed in a bottom portion of the cold air guide 339.

The cold air discharged through the refrigerating compartment cold-air auxiliary discharge hole 330 is not directly discharged toward the front surface of the refrigerating compartment 51. Rather, the cold air guide 339 changes a flow path direction from the frontward direction to the downward direction.

Accordingly, the cold air discharged through the refrigerating compartment cold-air auxiliary discharge hole 330 may primarily collide with the cold air guide 339.

When the cold air collides with the cold air guide 339 whose the surface is exposed to the relatively humid refrigerating compartment 51, dew formation may occur on the cold air guide 339.

For this reason, according to the present disclosure, the cold air guide 339 has the thermal insulating member 332 disposed in front of the refrigerating compartment filter 331, such that the occurrence of dew formation in the cold air guide 339 may be reduced.

The cold air guide 339 may be disposed to vertically overlap the refrigerating compartment cold-air collection duct 500 disposed under the refrigerating compartment 51.

That is, the refrigerating compartment cold-air auxiliary discharge hole 330 of the refrigerating compartment cold-air supply duct 300 may be disposed to overlap one end and the other end of the refrigerating compartment cold-air collection duct 500 disposed under the refrigerating compartment 51 in the vertical direction.

Accordingly, according to the present disclosure, the optimal cold air flow path may be defined, wherein when the cold air flows along the optimal cold air flow path, the cold air deodorized while flowing through the refrigerating compartment filter 331 may not interfere with the flow of the cold air circulating in the refrigerating compartment 51, and may be well discharged to the refrigerating compartment cold-air collection duct 500.

In addition, the refrigerating compartment cold-air main discharge guide 349 guides the cold air to be discharged in the frontward direction in the upper area of the refrigerating compartment 51. Thus, it may be difficult for the cold air guided by the refrigerating compartment cold-air main discharge guide 349 to circulate toward the rear surface 41a of the refrigerating casing 41.

In this regard, according to the present disclosure, the cold air discharged through the refrigerating compartment cold-air auxiliary discharge hole 330 may be circulated toward the rear surface 41a of the refrigerating casing, such that the overall supply of the cold air to the refrigerating compartment 51 may be performed in a more uniform and smooth manner.

In addition, a sterilizer 333 including an ultraviolet sterilizing device may be additionally disposed in the duct body 302.

The ultraviolet sterilization device may include an ultraviolet LED.

For example, the sterilizer 333 may be disposed under the first refrigerating compartment cold-air auxiliary discharge hole 330a and the second refrigerating compartment cold-air auxiliary discharge hole 330b and extend in a bar shape elongated in the left-right direction.

The sterilizer 333 may be disposed in rear of the refrigerating compartment filter 331 and be configured to sterilize the cold air having flowed through the refrigerating compartment filter 331 and then discharge the sterilized cold air to the refrigerating compartment 51.

### Refrigerating Compartment Filter Structure

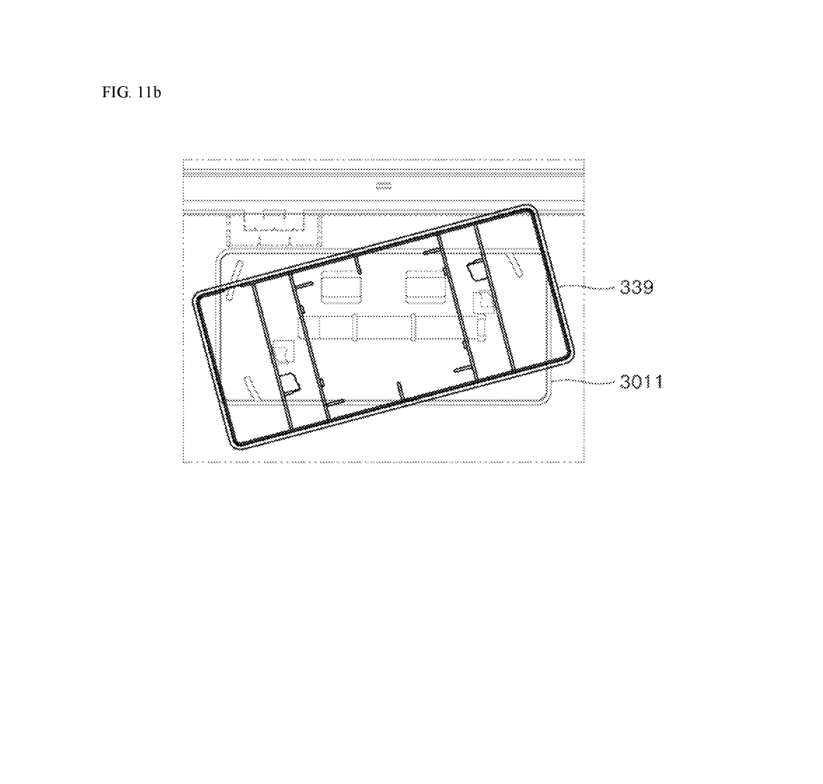

Hereinafter, the structure of the refrigerating compartment filter 331 of the present disclosure will be described with reference to FIGS. 11 to 17.

FIGS. 11A and 11B illustrate a method of detaching the refrigerating compartment filter 331 installed on the front surface of the cold air auxiliary discharge hole 330 from a conventional refrigerator.

The refrigerating compartment filter 331 is fixedly disposed inside the refrigerating compartment cold-air guide 339.

In addition, the refrigerating compartment cold-air guide 339 is coupled to a filter mounting portion 3011 disposed on one side surface of the refrigerating compartment cold-air supply duct 300 and defined by a protruding edge.

Accordingly, when the service life of the refrigerating compartment filter 331 has expired, the user has to grip and rotate the cold air guide 339 to be removed from the refrigerating compartment cold-air supply duct 300.

However, the upper door 20 is spaced apart from the cold air guide 339 by a considerable spacing. Thus, it is difficult for the user with a small body to grip the cold air guide 339 by hand and rotate the cold air guide 339 with a considerable force.

In addition, in order for the user to grip the cold air guide 339, a space required for the user to detach the refrigerating compartment filter 331 should be secured by removing the storage target stored in the refrigerator storage compartment in advance. This is inconvenient.

In addition, when the user has opened the upper door 20, the user may not check whether the refrigerating compartment filter 331 is mounted on the cold air guide 339 by checking only the cold air guide 339. For this reason, the user should remove the cold air guide 339 from the refrigerating compartment cold-air supply duct 300 and then check the manufacturing date or the mounting date of the refrigerating compartment filter 331. This is inconvenient.

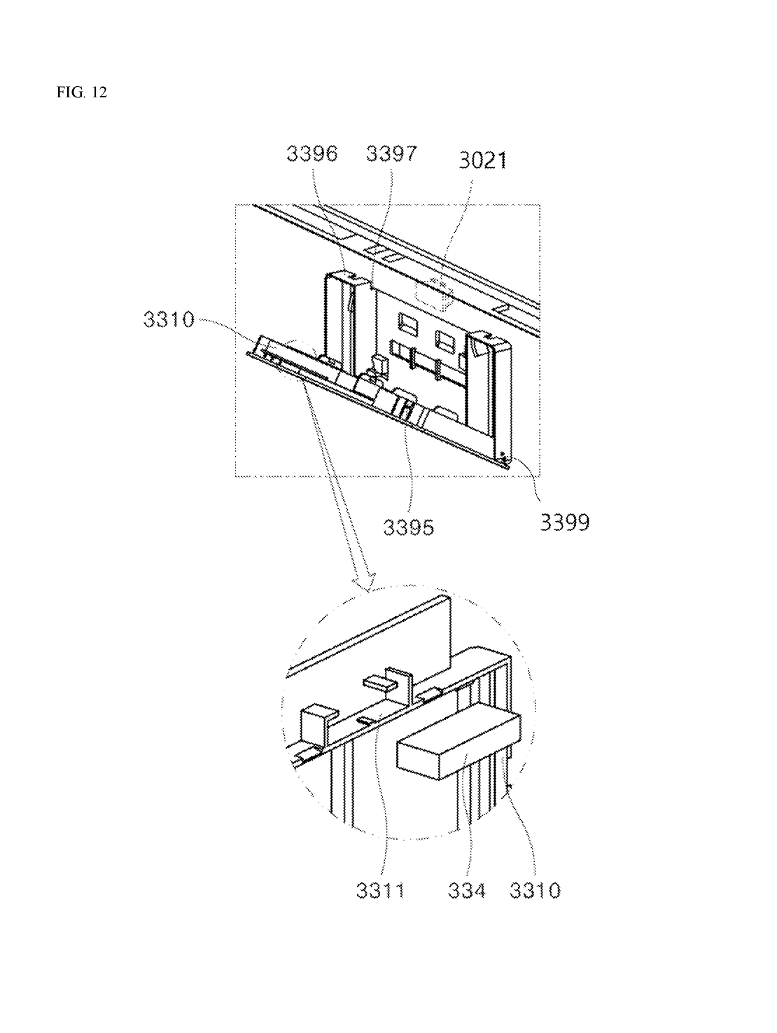

FIGS. 12 to 14 illustrate a configuration in which the refrigerating compartment cold-air guide 339 is detached from the refrigerating compartment cold-air supply duct 300 to replace the refrigerating compartment filter 331 in accordance with the present disclosure.

In the present disclosure, the user may downwardly pivot the cold air guide 339 accommodating the refrigerating compartment filter 331 thereon around a low end thereof such that an upper end of the cold air guide 339 is detached from the refrigerating compartment cold-air supply duct 300 and more easily replace the refrigerating compartment filter 331.

As illustrated in FIG. 11 and FIG. 12, the filter mounting portion 3011 is disposed on one side surface of the cold air supply duct 300 and is defined by the protruding edge. The cold air auxiliary discharge hole 330 is located in an inner area of the filter mounting portion 3011. A filter fixing portion 3012 is included in the filter mounting portion 3011.

A cold air guide fixing portion 3394 is rotatably fastened to the filter fixing portion 3012 and is fastened and fixed to the filter mounting portion 3011.

In addition, the cold air guide fixing portion 3394 may be removed from the filter mounting portion 3011 in a process opposite to the fastening process.

The cold air guide fixing portion 3394 serves to fix the cold air guide 339 to the refrigerating compartment cold-air supply duct 300.

The cold air guide fixing portion 3394 is installed to surround the outer surface of the protruding edge defining the filter mounting portion 3011.

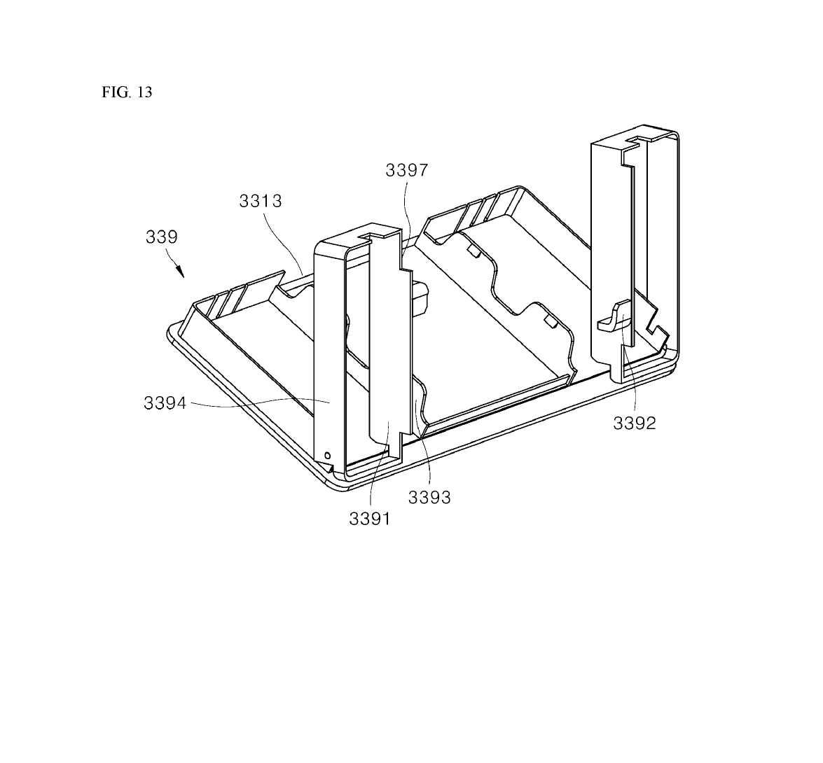

As illustrated in FIG. 13, each of a pair of support portions 3391 having a vertical frame shape is positioned inwardly of each of a pair of the cold air guide fixing portions 3394 and is connected to each of the pair of cold air guide fixing portions 3394.

A pair of pivot movement guide portions 3392 protrude on the inner side surfaces of the support portions 3391, respectively so as to face each other.

The pivot movement guide portion 3392 is engaged with the filter fixing portion 3012 and pivots and is fastened thereto, thereby serving to mount the cold air guide fixing portion 3394 onto the refrigerating compartment cold-air supply duct 300.

The cold air guide fixing portion 3394 surrounds the outer surface of the filter fixing portion 3011, whereas the support portion 3391 is installed inwardly of the cold air guide fixing portion 3394, so that a portion of the support portion 3391 contacts the filter fixing portion 3011 and interferes therewith.

Accordingly, the portion of the support portion 3391 which interferes with the filter fixing portion 3011 may be cut away such that a seat portion 3397 is formed. Thus, the interference may be removed.

A fixing opening 3396 is defined in an upper connection portion connecting the cold air guide fixing portion 3394 and the support portion 3391 to each other.

The fixing opening 3396 is a component for coupling the cold air guide fixing portion 3394 to the cold air guide 339 and will be described in detail below.

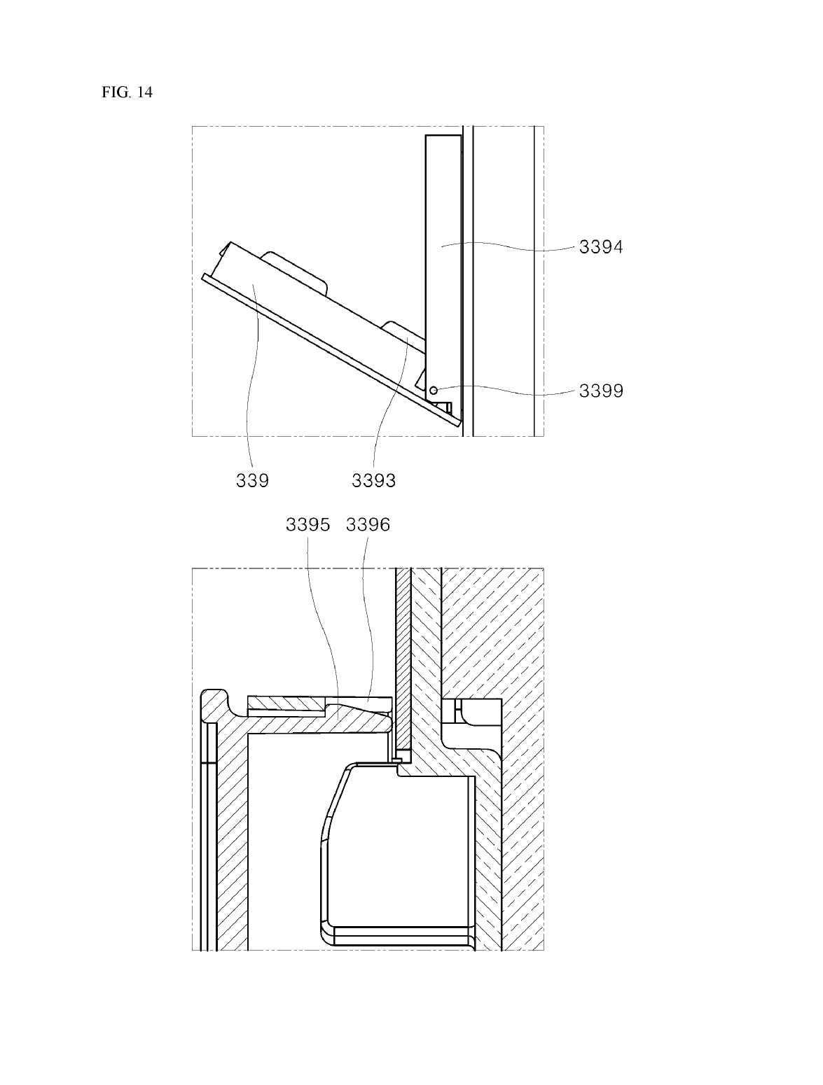

As illustrated in FIG. 14, a through-hole 3399 is defined in a lower end of each of the pair of cold air guide fixing portions 3394.

The through-hole 3399 is a component for hinge-coupling the cold air guide fixing portion 3394 with the cold air guide 339. As described above, in order to solve the inconvenience caused by an entirety of the cold air guide 339 being attached to and detached from the refrigerating compartment cold-air supply duct 300 in the conventional manner, the cold air guide 339 may downwardly pivot around the lower end thereof such that the upper end thereof is removed from the cold air guide fixing portion 3394.

That is, only the upper end of the cold air guide 339 downwardly pivots around the lower end thereto such that the upper end of the cold air guide 339 moves to be closer to the upper door 20. Thus, the filter mounting portion 3011 is opened so that the user may easily take out the refrigerating compartment filter 339 from the opened filter mounting portion 3011.

In the present disclosure, the cold air guide 339 has a rectangular frame shape, and has an opening 3313 formed in the center of the upper end thereof to serve as an access channel through which a filter casing 3310 in which the refrigerating compartment filter 339 is accommodated is inserted into the cold air guide 339.

A protrusion inserted into the through-hole 3399 is formed on each of both opposing side surfaces of the lower end of the outer frame of the cold air guide 339.

Accordingly, the protrusion is inserted into the through-hole 3399 and thus acts as a pivot hinge. Thus, the upper end of the cold air guide 339 pivots around the hinge formed at the lower end of the cold air guide fixing portion 3394 and the lower end of the cold air guide 339.

Accordingly, as illustrated in FIG. 12, the user may detach the filter casing 3310 in which the refrigerating compartment filter 331 is accommodated from the cold air guide 339 through the opening 3313 defined in the upper end of the cold air guide 339.

The cold air guide 339 is tilted or pivots downwardly such that the upper end thereof moves closer toward the upper door 20. Thus, the user may simply replace the refrigerating compartment filter 331 without bending forward and holding and rotating the entirety of the cold air guide 339 to replace the refrigerating compartment filter 331 in the conventional manner.

Each of a pair of filter casing fixing portions 3393 having a vertical frame shape is positioned inwardly of the outer frame of the cold air guide 339.

An upper end of the filter casing fixing portion 3393 is coupled to the upper surface of the cold air guide 339.

A spacing between the filter casing fixing portion 3393 and the center of the cold air guide 339 may be smaller than a spacing between the support portion 3391 and the center of the cold air guide 339.

For example, the filter casing fixing portion 3393 serves to fix the filter casing 3310.

Therefore, a spacing between the pair of filter casing fixing portions 3393 may be set to be equal to or greater than the width of the filter casing 3310.

The filter casing fixing portions 3393 serve to fix both opposing side surfaces of the filter casing 3310 and to guide the movement of the filter casing 3310 when the filter casing is inserted into or removed from the cold air guide 339 through the opening 3313.

A protrusion for fixing each of the front and rear surfaces of the filter casing 3310 may be formed on one side of the filter casing fixing portion 3393.

A fixing protrusion 3395 is formed on an upper connection portion connecting the cold air guide 339 and the filter casing fixing portion 3393 to each other and is elastically fastened to the fixing opening 3396.

The fixing protrusion 3395 may have a hook shape in which a portion of a body thereof protrudes upwardly.

Accordingly, when the user presses the upwardly protruding portion of the fixing protrusion 3395, the fixing protrusion 3395 moves downwardly so as to be positioned under the fixing opening 3396, such that the fastening force is released, so that the upper end of the cold air guide 339 may be removed from the cold air guide fixing portion 3394.

On the contrary, the user may push the upper end of the cold air guide 339 toward the cold air guide fixing portion 3394 fixed to the refrigerating compartment cold-air supply duct 300 such that the upwardly protruding portion of the fixing protrusion 3395 is inserted into the fixing opening 3396 under the elastic force. Thus, the cold air guide 339 may be fixed to the cold air guide fixing portion 3394.

According to the present embodiment, in order to replace the refrigerating compartment filter 331, the user may press down the fixing protrusion 3395 and easily remove and reinsert the filter casing 3310 in which the refrigerating compartment filter 331 is accommodated through the opening 3313, instead of gripping and rotating the cold air guide 339 and removing the same from the refrigerating compartment cold-air supply duct 300 in the conventional manner.

In addition, the cold air guide fixing portion 3394 detachably coupled to the filter mounting portion 3011, the cold air guide 339 having the both opposing lower ends respectively hinge-coupled to the lower ends of the pair of cold air guide fixing portions 3394 such that the upper end of the cold air guide 339 pivots around the lower end thereof, the filter casing 3310 fixedly inserted into the inner space of the cold air guide 339, and the refrigerating compartment filter 331 inserted into the filter casing 3310 to filter the cold air supplied to the cold air discharge hole may constitute one assembly. The cold air guide fixing portion 3394 may be removed from the filter mounting portion 3011 and thus be simply disassembled from the assembly.

### Reed Sensing System

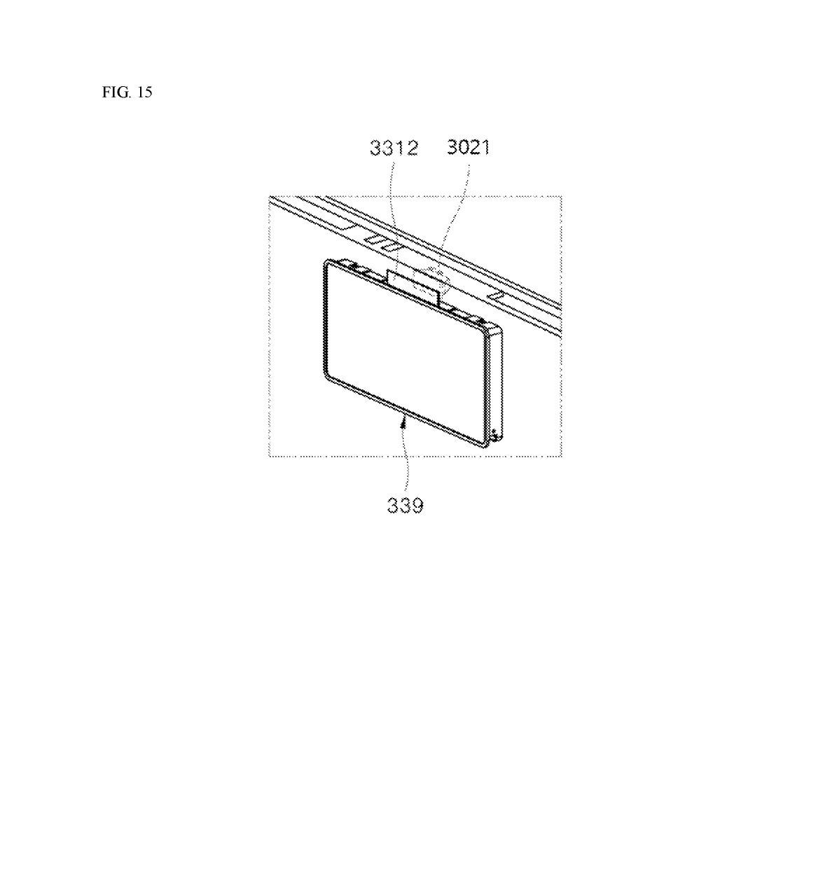

A reed sensing system of the present disclosure will be described with reference to FIGS. 15 to 18.

As described above, in the conventional refrigerating compartment filter 331, there is a problem in that the user outside the refrigerator may not check whether the refrigerating compartment filter 331 is mounted and the time at which the refrigerating compartment filter was mounted .

Accordingly, in an embodiment to be described below, a method in which the user may check whether the refrigerating compartment filter 331 is installed in the cold air guide 339, the installation time of the refrigerating compartment filter 331, the remaining service life thereof, etc. is presented.

As shown in FIG. 15, a display 3312 is installed on an upper end of the filter casing 3310.

The display 3312 serves as a display for allowing the user outside the refrigerator to identify that the filter casing 3310 has been installed inside the cold air guide 339.

When the display 3312 is visible to the user in a state in which the upper door 20 is opened, the user may identify that the refrigerating compartment filter 3312 has been installed.

The display 3312 may display a mounting date, a filter type, or an inspection date of the refrigerating compartment filter 331.

For example, when the mounting date of the refrigerating compartment filter 331 is displayed on the display 3312, the user may predict the remaining life based on the mounting date displayed on the display 3312.

In an example, the previous inspection date of the refrigerating compartment filter 331 and a contact number of an inspector may be displayed on the display 3312.

Accordingly, the user may check a next replacement date based on the installation or mounting date of the refrigerating compartment filter 331. On the other hand, if a failure or a problem occurs in the filter, the user may directly contact the inspector to solve the problem or the failure.

A magnet mount 3311 into which a magnet 334 may be inserted and installed may be positioned at a vertical level corresponding to a lower end of the display 3312 and be disposed on the upper end of the filter casing 3310.

When the cold air guide 339 is coupled to the cold air guide fixing portion 3394, a reed sensor 3021 for detecting whether the magnet 334 is installed may be installed at a position of the refrigerating compartment cold-air supply duct facing the magnet 334.

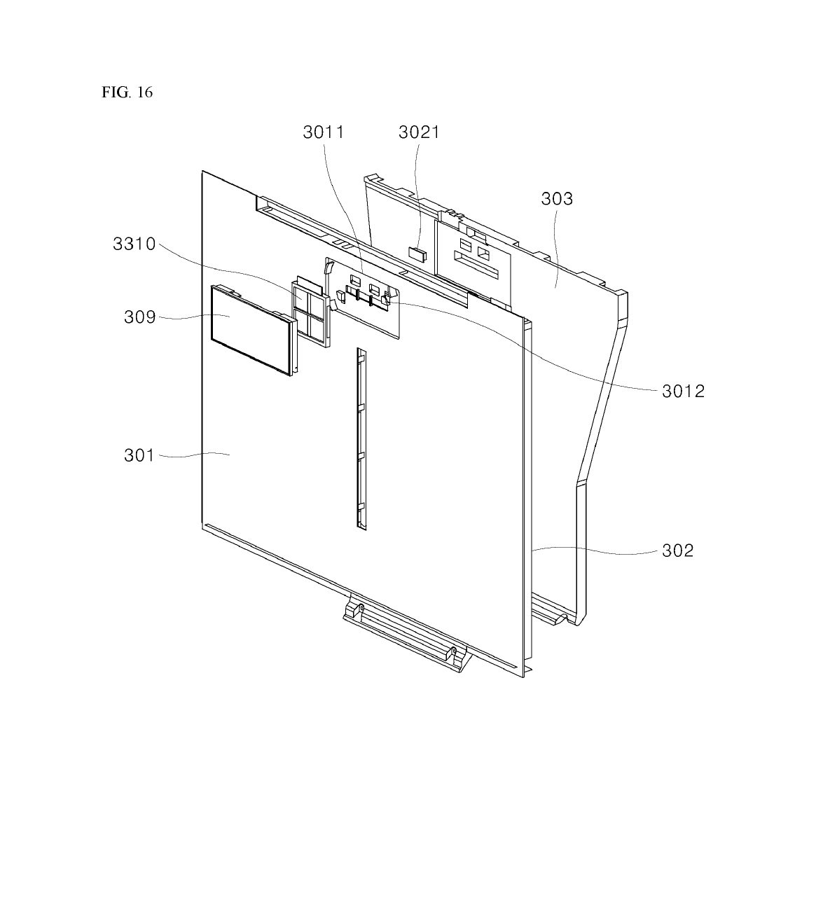

Specifically, as illustrated in FIG. 16, the reed sensor 3021 may be installed on the duct body 302 of the refrigerating compartment cold-air supply duct 300.

The reed sensor 3021 may determine whether the refrigerating compartment filter 331 is installed in the filter casing 3310 based on whether the magnet 334 is installed.

The measurement information of the reed sensor 3021 may be transmitted to the display 5100 or a speaker.

That is, only in response to that the display 3312 is installed, the user should open the upper door 20 and visually check the display 3312.

On the other hand, when the user can check whether the refrigerating compartment filter 331 is installed using the reed sensor 3021, the user may obtain various information related to the installation of the refrigerating compartment filter 331 based on the measurement information of the reed sensor 3021 without having to open the upper door 20 to check the installation of the refrigerating compartment filter 331.

That is, the measurement information of the reed sensor 3021 may be displayed on the display 5100, such that the user may check whether the refrigerating compartment filter 331 is installed and the remaining service life of the refrigerating compartment filter 331 without the user removing or displacing the storage items loaded in the refrigerating compartment 51.

To this end, the measurement information of the reed sensor 3021 may be transmitted to the display 5100 through a wire connected to the reed sensor 3021.

In this regard, the measurement information of the reed sensor 3021 may be connected to a printed circuit board (PCB) installed on the rear surface of the inner casing 40 of the refrigerator 1 before being transmitted to the display 5100.

The PCB may be installed outside the refrigerating compartment 51 to secure a storage space of the refrigerator 1 and, on the other hand, to simplify the inside of the refrigerator 1 to improve aesthetics.

In addition, since the PCB is installed outside the refrigerating compartment 51, a failure of the PCB due to a low temperature may be prevented in advance.

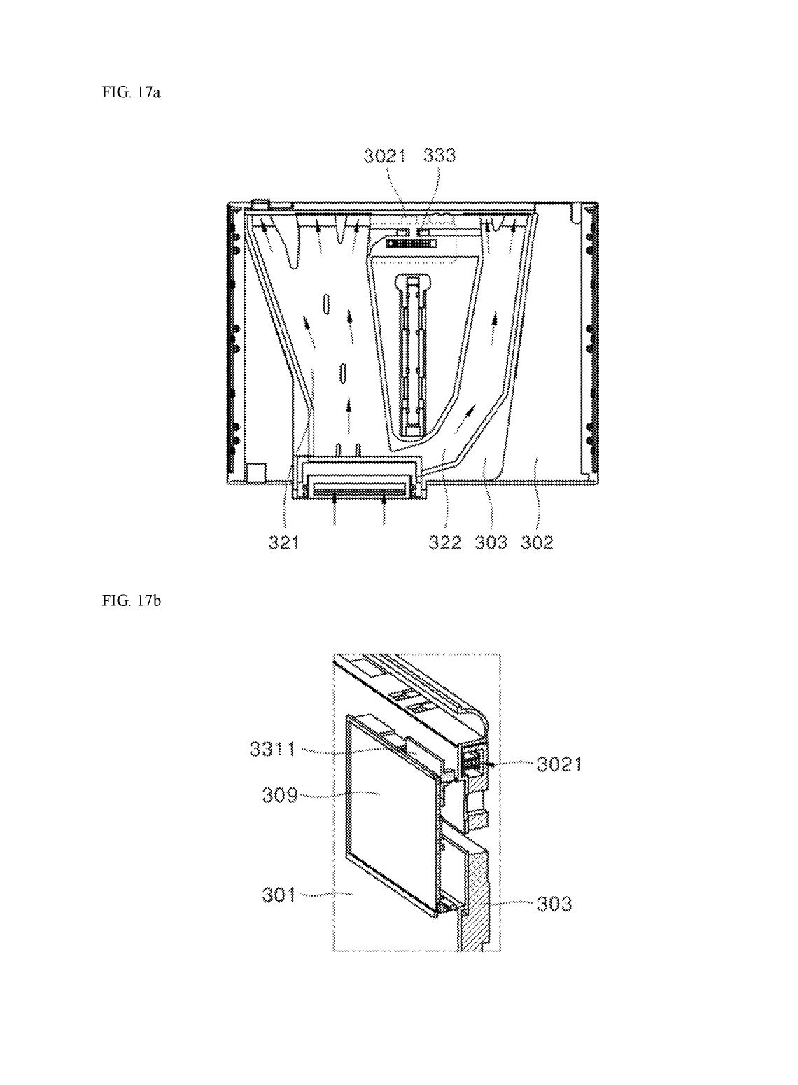

FIG. 17A illustrates a front view in which the reed sensor 3021 is installed on the duct body 302.

The refrigerating compartment cold-air auxiliary discharge hole 330 is defined in the duct body 302, and is disposed between the first refrigerating compartment cold-air flow path 321 and the second refrigerating compartment cold-air flow path 322. The refrigerating compartment cold-air auxiliary discharge hole 330 is formed at an upper end of an area defined between the two cold air flow paths.

The refrigerating compartment cold-air flow path and the refrigerating compartment cold-air auxiliary discharge hole 330 may be installed at an upper end of the duct body 302 to uniformly transmit the cold air to the refrigerating compartment 51, and may supply the cold air from an upper area to a lower area of the refrigerating compartment.

That is, the first refrigerating compartment cold-air flow path 321 and the second refrigerating compartment cold-air flow path 322 are respectively positioned on the left and right sides of the reed sensor 3021, and the cold air auxiliary discharge hole 330 is positioned under the reed sensor 3021.

The reed sensor 3021 is configured to sense a magnetic field of the magnet 334, and is not greatly affected by temperature. However, when the refrigerator operates in a humid environment, the cold air and moisture supplied to the refrigerating compartment 51 may react with each other to cause the dew formation on the reed sensor 3021.

The dew formed on the reed sensor 3021 may continuously change a phase thereof into ice and water according to the strong cold air supplied to the refrigerating compartment 51 and the opening and closing of the door.

Such a phase change of the dew leads to a volume change thereof, thereby causing cracks in a casing sealing the reed sensor 3021 to cause corrosion or electrical insulation deterioration, thereby causing a decrease in sensing accuracy and service life of the reed sensor.

In addition, moisture infiltrating into the reed sensor 3021 results in a short circuit or interference with the circuit. This not only causes the failure of the reed sensor 3021 itself or shortens the service life thereof, but also causes the failure of the PCB connected thereto or shortens the service life thereof.

Therefore, it is preferable that the reed sensor 3021 always operates within a constant temperature range without being affected by external cold air.

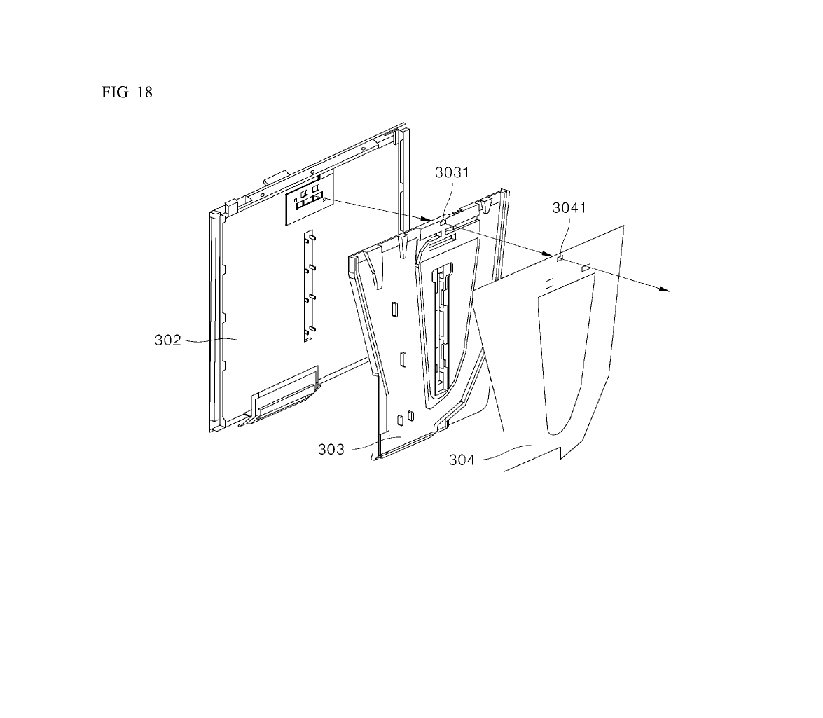

A role and a function of the PCB will be described in detail with reference to FIG. 18.

FIG. 17B illustrates that the reed sensor 3021 is installed in a thermally insulated space defined by a partition wall formed at one side of the duct body 302 and thus is thermally insulated from the cold air.

The partition wall defining the thermally insulated space receiving therein the reed sensor 3021 may be integrally formed with the duct body 302.

In an example, the partition wall protecting the reed sensor 3021 from the cold air may be installed in a structure in which the partitional wall is removably mounted on the duct body 302 using a separate fastening means or the like.

In this regard, the partition wall that blocks the transfer of thermal energy between the reed sensor 3021 and the refrigerating compartment is surrounded with the duct thermal insulation portion 303, so that the reed sensor 3021 may be doubly protected from the cold air or temperature change of the refrigerating compartment 51.

For example, the partition wall protecting the reed sensor 3021 may be formed on one side of the duct thermal insulating portion 303.

For example, the partition wall protecting the reed sensor 3021 may be formed such that the duct body 302 and the duct thermal insulating portion 303 face each other in a complementary manner.

For example, the thermally insulated space may be defined between the duct body 302 on which the reed sensor 3021 is installed and the duct thermal insulation portion 303.

The thermally insulated space may prevent the cold air transferred from the first refrigerating compartment cold-air flow path 321, the second refrigerating compartment cold-air flow path 322, and the refrigerating compartment cold-air auxiliary discharge hole 330 from being transferred to the reed sensor 3021 in a conduction manner.

In addition, the thermally insulated space may provide a space in which a tool is inserted when the reed sensor 3021 is replaced or repaired, or a space for a repairman to grip the same.

As illustrated in FIG. 18, the measurement information of the reed sensor 3021 may be transmitted to the PCB via the wire passing through a first hole 3031 and a second hole 3041 respectively formed at the upper ends of the duct thermal insulation portion 303 and the duct sheet 304 and connected to the reed sensor 3021.

The wire passes through the hole formed in the upper portion of the refrigerator 1 and is connected to the reed sensor 3021, thereby preventing the cold air in the storage compartment from being leaked to the outside.

The PCB includes a microcomputer that performs an algorithm for performing a function of the refrigerator 1.

The PCB may include a memory storing therein the replacement time of the refrigerating compartment filter 331, the remaining service life, maintenance manager information, and the like thereof based on the measurement information of the reed sensor 3021.

The PCB may transmit the measurement information to a user terminal connected to a network through an internal communication unit.

When the service life of the refrigerating compartment filter 331 has expired or the replacement time of the refrigerating compartment filter 331 is approaching, the PCB may notify the user of the above situation in a visual or auditory manner through the display 5100 or a speaker.

In this case, the PCB may be pre-programmed to simultaneously transmit the information to the user terminal through the communication unit connected through the network.

Although the embodiments of the present disclosure have been described in more detail with reference to the accompanying drawings, the present disclosure is not necessarily limited to these embodiments, and may be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects. In addition, even though an effect of a configuration of the present disclosure is not explicitly described in describing the embodiment of the present disclosure above, it is obvious that the predictable effect from the configuration should be recognized.

What is claimed is:

1. A refrigerator comprising:
a refrigerator compartment cold-air supply duct installed on one side surface of the refrigerator compartment and configured to receive cold air generated from an evaporator via a connection duct;
a filter mounting portion disposed on one side surface of the refrigerating compartment cold-air supply duct and defined by a protruding edge;
a pair of filter fixing portions disposed in an inner area of the filter mounting portion and spaced from each other;
a pair of cold air guide fixing portions spaced from each other and rotatably coupled to the pair of filter fixing portions, respectively, and fixed to the filter mounting portion;
a cold air guide having a lower end hinge-coupled to lower ends of the pair of cold air guide fixing portions, wherein an opening is defined in the upper end of the cold air guide, wherein a pair of filter casing fixing portions are disposed on an inner side surface of the cold air guide and are integrally formed therewith; and
a filter casing configured to receive therein a refrigerator compartment filter, wherein the filter casing is configured to pass through the opening so as to be inserted into the cold air guide and into a space defined between the pair of filter casing fixing portions, and to pass through the opening so as to be removed from the cold air guide.

2. The refrigerator of claim 1, wherein the hinge-coupling is achieved such that protrusions respectively formed on both opposing sides of the lower end of the cold air guide are respectively inserted into hinge grooves respectively defined in the lower ends of the pair of cold air guide fixing portions.

3. The refrigerator of claim 2, wherein a display is disposed on an upper end of the filter casing and extends upwardly from the upper end thereof.

4. The refrigerator of claim 2, wherein fixing protrusions are respectively formed on both opposing side ends of an upper surface of the cold air guide,
wherein fixing openings are respectively defined at upper ends of the pair of cold air guide fixing portions,
wherein the fixing protrusions are elastically coupled to the fixing openings such that that the cold air guide is coupled to the pair of cold air guide fixing portions.

5. The refrigerator of claim 4, wherein when the cold air guide is coupled to the pair of cold air guide fixing portions, a refrigerating compartment cold-air auxiliary discharge hole is formed in one side surface of the refrigerating compartment cold-air supply duct facing the refrigerating compartment filter,
wherein cold air is supplied through the refrigerating compartment cold-air auxiliary discharge hole to the refrigerating compartment.

6. The refrigerator of claim 5, wherein a magnet receiving portion is disposed on the upper end of the filter casing and is positioned at a vertical level corresponding to a lower end of the display,
wherein a magnet is inserted into and installed in the magnet receiving portion.

7. The refrigerator of claim 3, wherein the refrigerating compartment cold-air supply duct includes:
a duct body defining a front surface shape thereof;
a duct sheet spaced apart from the duct body and disposed in rear of the duct body; and
a duct thermal insulation portion provided between the duct body and the duct sheet and configured to have a first refrigerating compartment cold-air flow path and a second refrigerating compartment cold-air flow path defined therein, wherein along the first refrigerating compartment cold-air flow path and the second refrigerating compartment cold-air flow path, the cold air is supplied to the refrigerating compartment.

8. The refrigerator of claim 7, wherein a reed sensor configured to sense whether the magnet is mounted is installed on the duct body and at a position of the duct body facing the magnet when the cold air guide and the cold air guide fixing portions are fastened to each other.

9. The refrigerator of claim 8, wherein the reed sensor is installed in a separate space insulated from cold air or moisture.

10. The refrigerator of claim 9, wherein the refrigerator comprises a printed circuit board (PCB) configured to determine display whether the refrigerating compartment filter is mounted or not and a replacement time of the refrigerating compartment filter based on measurement information from the reed sensor and to display whether the refrigerating compartment filter is mounted or not and the replacement time of the refrigerating compartment filter on a display installed on one side of the refrigerator.

11. The refrigerator of claim 9, wherein the PCB is installed on a rear surface of an inner casing facing the duct sheet.

12. The refrigerator of claim 11, wherein the measurement information from the reed sensor is transmitted to the PCB via a wire,
wherein the wire passes through a first through hole and a second through hole respectively formed in an upper end of the duct thermal insulation portion and an upper end of the duct sheet and is connected to the reed sensor.

13. A filter assembly comprising:
a cold air discharge hole configured to discharge cold air to a refrigerating compartment;
a filter mounting portion defined by a protruding edge extending so as to surround the cold air discharge hole;
a pair of cold air guide fixing portions detachably coupled to the filter mounting portion;
a cold air guide having a lower end hinge-coupled to lower ends of the pair of cold air guide fixing portions such that an upper end of the cold air guide pivots around the lower end thereof so as to close or open the filter mounting portion, wherein an opening is defined in an upper end of the cold air guide; and
a filter casing configured to pass through the opening so as to be inserted into the cold air guide or be removed from the cold air guide, wherein a display is installed on an upper end of the filter casing, wherein the filter casing is received in the cold air guide and is fixedly disposed in a central area of the cold air guide; and
a refrigerating compartment filter inserted into the filter casing and configured to filter the cold air to be supplied to the cold air discharge hole.

14. The filter assembly of claim 13, wherein in a state in which the filter casing has been fully inserted into the cold air guide, the display protrudes upwardly through the opening so as to be exposed to an outside out of the cold air guide.

15. The filter assembly of claim 13, wherein a magnet receiving portion is disposed on the upper end of the filter casing and is positioned at a vertical level corresponding to a lower end of the display,
wherein a magnet is inserted into and installed in the magnet receiving portion.

16. The filter assembly of claim 15, wherein the cold air discharge hole is defined in a refrigerating compartment cold-air supply duct configured to transmit the cold air generated from an evaporator,
wherein a reed sensor configured to detect whether the magnet is mounted is installed at a position of the refrigerating compartment cold-air supply duct facing the magnet.

17. The filter assembly of claim 13, wherein a pair of filter casing fixing portions are disposed on an inner side surface of the cold air guide and configured to secure both opposing side surfaces of the filter casing.

18. The filter assembly of claim 13, wherein fixing protrusions are respectively formed on both opposing side ends around the opening of an upper surface of the cold air guide,
wherein fixing openings are respectively defined at upper ends of the pair of cold air guide fixing portions,
wherein the fixing protrusions are elastically coupled to the fixing openings such that that the cold air guide is coupled to the pair of cold air guide fixing portions.

19. The filter assembly of claim 13, wherein each of a pair of support portions is disposed inwardly of each of the cold air guide fixing portions, wherein an upper connection portion connects each of the cold air guide fixing portions and each of the pair of support portions to each other,
wherein a pivot movement guide portion is formed on one side of each of the support portions.

20. The filter assembly of claim 19, wherein the pivot movement guide portion is rotatably fastened to a filter fixing portion formed between the cold air discharge hole and the protruding edge defining the filter mounting portion.
